(19) United States
(12) Patent Application Publication
(10) Pub. No.: US 2025/0304811 A1
(43) Pub. Date: Oct. 2, 2025

(54) Ink Jet Ink Composition And Recording Method

(71) Applicant: SEIKO EPSON CORPORATION, Tokyo (JP)

(72) Inventors: Takako SUGIYAMA, Azumino (JP); Yuta ASAKAWA, Azumino (JP); Keigo ANDO, Matsumoto (JP)

(21) Appl. No.: 19/090,672

(22) Filed: Mar. 26, 2025

(30) Foreign Application Priority Data
Mar. 27, 2024 (JP) 2024-051362

(51) Int. Cl. C09D 11/38; B41M 5/00; C09D 11/107; C09D 11/322

(52) U.S. Cl. CPC C09D 11/38; B41M 5/0047; B41M 5/0064; C09D 11/107; C09D 11/322

(57) ABSTRACT

An ink jet ink composition according to an embodiment of the present disclosure is a water-based ink jet ink composition. The ink jet ink composition is used for recording on a recording medium that is a low-absorbent recording medium or a non-absorbent recording medium. The ink jet ink composition contains a pigment, resin particles, a surfactant, and a poorly water-soluble low-molecular-weight organic compound that is either an alkanediol or a glycol ether and that has a solubility in water of 10 g/100 g of water or less. The surfactant contains a silicone-based surfactant and an acetylene glycol-based surfactant having an HLB value of 9 to 14. The ink jet ink composition has a pH of 8 to 10.

The present application is based on, and claims priority from JP Application Serial Number 2024-051362, filed Mar. 27, 2024, the disclosure of which is hereby incorporated by reference herein in its entirety.

### BACKGROUND

### 1. Technical Field

The present disclosure relates to an ink jet ink composition and a recording method.

### 2. Related Art

There is known an ink jet recording method that ejects minute ink droplets from a nozzle of an ink jet head of an ink jet recording apparatus to record an image on a recording medium. For example, it is considered to be used in sign printing, label printing, package printing, and the like. In the consideration, studies have been made on recording an image on a recording medium that is a low-absorbent recording medium or a non-absorbent recording medium (hereinafter, also referred to as a “low- or non-absorbent recording medium”) using an ink containing at least water as a solvent (hereinafter, also referred to as a “water-based ink”).

For example, JP-A-2022-154397 describes a water-based ink containing a silicone-based surfactant and a poorly water-soluble organic compound that is a diol or a glycol ether.

However, the water-based ink is not sufficient for obtaining excellent image quality and excellent clogging recoverability of an ink jet head.

### SUMMARY

An ink jet ink composition according to an aspect of the present disclosure is a water-based ink jet ink composition. The ink jet ink composition is used for recording on a recording medium that is a low-absorbent recording medium or a non-absorbent recording medium. The ink jet ink composition contains a pigment, resin particles, a surfactant, and a poorly water-soluble low-molecular-weight organic compound that is either an alkanediol or a glycol ether and that has a solubility in water of 10 g/100 g of water or less. The surfactant contains a silicone-based surfactant and an acetylene glycol-based surfactant having an HLB value of 9 to 14. The ink jet ink composition has a pH of 8 to 10.

A recording method according to an aspect of the present disclosure includes ejecting the ink jet ink composition according to the above aspect from an ink jet head to cause the ink jet ink composition to adhere to a recording medium that is a low-absorbent recording medium or a non-absorbent recording medium.

### BRIEF DESCRIPTION OF THE DRAWINGS

FIG. 1 is a schematic diagram of an example of an ink jet recording apparatus.

FIG. 2 is a schematic diagram of the vicinity of a carriage of the example of the ink jet recording apparatus.

FIG. 3 is a table of composition examples of ink jet ink compositions.

FIG. 4 is a table of composition examples of ink jet ink compositions.

FIG. 5 is a table of the evaluation results of Examples and Comparative Examples.

### DESCRIPTION OF EMBODIMENTS

Embodiments of the present disclosure will be described below. The embodiments described below illustrate examples of the present disclosure. The present disclosure is not limited to the following embodiments in any way, and includes various modifications implemented without departing from the gist of the present disclosure. It should be noted that not all of the configurations described below are essential configurations of the present disclosure.

In the present specification, a numerical range represented by using “to” means a range including numerical values described before and after “to” as a lower limit value and an upper limit value.

In the present specification, the term “(meth)acrylic” means acrylic or methacrylic. The term “(meth)acrylate” means acrylate or methacrylate.

### 1. INK JET INK COMPOSITION

An ink jet ink composition according to an embodiment of the present disclosure is a water-based ink jet ink composition. The ink jet ink composition is used for recording on a recording medium that is a low-absorbent recording medium or a non-absorbent recording medium. The ink jet ink composition contains a pigment, resin particles, a surfactant, and a poorly water-soluble low-molecular-weight organic compound that is either an alkanediol or a glycol ether and that has a solubility in water of 10 g/100 g of water or less. The surfactant contains a silicone-based surfactant and an acetylene glycol-based surfactant having an HLB value of 9 to 14. The ink jet ink composition has a pH of 8 to 10.

In recording using a water-based ink on a low- or non-absorbent recording medium, since the water-based ink is less likely to wet and spread on the recording medium (filling is poor), streak-like unevenness or the like appears in a recorded image due to a slight deviation in the amount of ink droplets ejected from a nozzle or a slight deviation in landing position, and thus it is difficult to obtain good image quality. Against this, by further adding a poorly water-soluble low-molecular-weight organic compound to a water-based ink containing a silicone-based surfactant, it is possible to improve the wetting and spreading of the ink on a low- or non-absorbent recording medium and to obtain good image quality.

However, it has been found that when the poorly water-soluble low-molecular-weight organic compound is added to the water-based ink, the dispersion of a pigment and resin particles is destabilized, and the clogging recoverability of an ink jet head (hereinafter, also simply referred to as “clogging recoverability”) deteriorates. It is presumed that this is because the poorly water-soluble low-molecular-weight organic compound has strong hydrophobicity, and when the ink is dried by evaporation of water in the vicinity of the nozzle of the ink jet head, the ratio of a hydrophobic component in the ink relatively increases, and thus the dispersion of the pigment and the resin particles, which are stable in a state in which the ratio of a hydrophilic component is high, is destabilized, and aggregation occurs.

According to knowledge in the related art, clogging recoverability can be improved by increasing the pH of the ink in some cases. This is because the dispersion of the pigment and the resin particles tends to be stabilized by setting the pH of the ink to be closer to alkalinity, and thus the occurrence of aggregation can be reduced even when water is evaporated due to drying of the ink. However, in a water-based ink containing a silicone-based surfactant, when the alkalinity becomes too high, hydrolysis of the silicone-based surfactant is promoted, and the hydrophilic-hydrophobic balance of the entire components in the ink is lost over time. As a result, the dispersion of the pigment and the resin particles is destabilized, and clogging recoverability deteriorates. On the other hand, when the pH of the ink is not set to be closer to alkalinity, the dispersion of the pigment and the resin particles is destabilized.

The present inventors have conducted intensive studies and consequently have found that by further adding an acetylene glycol-based surfactant having an HLB value of 9 to 14, it is possible to improve the dispersion stability of the pigment and the resin particles and to improve clogging recoverability. The acetylene glycol-based surfactant has a property of being compatible with the poorly water-soluble low-molecular-weight organic compound and has a property of being less likely to be hydrolyzed even when the pH is closer to alkalinity. Thus, it is presumed that it is possible to improve the solubility of the poorly water-soluble low-molecular-weight organic compound and to maintain the hydrophilic-hydrophobic balance of the entire components even in an ink under an alkaline environment. Therefore, even if the ink contains a silicone-based surfactant and has a pH closer to alkalinity, it is possible to improve the dispersion stability of the pigment and the resin particles and to inhibit them from forming foreign matter.

Thus, the ink jet ink composition according to the present embodiment can provide excellent image quality and excellent clogging recoverability of an ink jet head.

Components contained in the ink jet ink composition according to the present embodiment will be described below.

### 1.1 Pigment

The ink jet ink composition according to the present embodiment contains a pigment. A pigment has a property of being less likely to be discolored by light, gas, or the like. An image formed on a recording medium using a pigment is not only excellent in image quality but also excellent in water resistance, gas resistance, lightfastness, and the like, and has good storage stability. These properties are particularly remarkable when an image is formed on a recording medium that is a low-absorbent recording medium or a non-absorbent recording medium.

The pigment is not particularly limited, and examples thereof include inorganic pigments and organic pigments. As the inorganic pigments, in addition to titanium oxide and iron oxide, carbon black produced by a known method such as the contact method, the furnace method, or the thermal method can be used. On the other hand, as the organic pigments, for example, azo pigments, polycyclic pigments, nitro pigments, nitroso pigments, aniline black, and the like can be used. Examples of the azo pigments include azo lakes, insoluble azo pigments, condensed azo pigments, and chelate azo pigments. Examples of the polycyclic pigments include phthalocyanine pigments, perylene pigments, perinone pigments, anthraquinone pigments, and quinophthalone pigments.

Examples of a pigment for use in a black ink include carbon black. The carbon black is not particularly limited, and examples thereof include furnace black, lamp black, acetylene black, channel black (C.I. Pigment Black 7), and, as commercially available products, No. 2300, 900, MCF88, No. 20B, No. 33, No. 40, No. 45, No. 52, MA7, MA8, MA77, MA100, No. 2200B, and the like (all of which are product names, manufactured by Mitsubishi Chemical Corporation), Color Black FW1, FW2, FW2V, FW18, FW200, S150, S160, and S170, Pretex 35, U, V, and 140U, Special Black 6, 5, 4A, 4, and 250, and the like (all of which are product names, manufactured by Degussa), Conductex SC, Raven 1255, 5750, 5250, 5000, 3500, 1255, and 700, and the like (all of which are product names, manufactured by Columbia Carbon Inc.), Regal 400R, 330R, and 660R, Mogul L, Monarch 700, 800, 880, 900, 1000, 1100, 1300, and 1400, Elftex 12, and the like (all of which are product names, manufactured by Cabot Japan K.K.).

A pigment for use in a white ink is not particularly limited, and examples thereof include white inorganic pigments such as C.I. Pigment White 6, 18, and 21, titanium oxide, zinc oxide, zinc sulfide, antimony oxide, magnesium oxide, and zirconium oxide. Apart from the white inorganic pigments, white organic pigments such as white hollow resin fine particles and polymer particles can also be used.

A pigment for use in a yellow ink is not particularly limited, and examples thereof include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 155, 167, 172, and 180.

A pigment for use in a magenta ink is not particularly limited, and examples thereof include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245; C.I. Pigment Violet 19, 23, 32, 33, 36, 38, 43, and 50; and solid solutions of the above pigments.

A pigment for use in a cyan ink is not particularly limited, and examples thereof include C.I. Pigment Blue 1, 2, 3, 15, 15:1, 15:2, 15:3, 15:4, 16, 18, 22, 25, 60, 65, and 66; and C.I. Vat Blue 4 and 60.

In addition, a pigment for use in color inks other than magenta, cyan, and yellow inks is not particularly limited, and examples thereof include C.I. Pigment Green 7 and 10; C.I. Pigment Brown 3, 5, 25, and 26; and C.I. Pigment Orange 1, 2, 5, 7, 13, 14, 15, 16, 24, 34, 36, 38, 40, 43, and 63.

A pearl pigment is not particularly limited, and examples thereof include pigments having pearl luster or interference luster, such as titanium dioxide coated mica, fish scale foil, and bismuth oxychloride.

A metallic pigment is not particularly limited, and examples thereof include particles formed of elemental metals, such as aluminum, silver, gold, platinum, nickel, chromium, tin, zinc, indium, titanium, and copper, and alloys thereof.

One of the pigments may be used alone, or two or more thereof may be used in combination.

The pigment may be present in a state of being dispersed in the ink composition, that is, as a pigment dispersion. Here, “pigment dispersion” in the present specification includes a pigment dispersion liquid and a slurry (low viscosity aqueous dispersion) of a pigment.

Examples of the pigment dispersion include, but are not limited to, self-dispersed pigments, polymer-dispersed pigments, and polymer-coated pigments.

The self-dispersed pigment is a pigment that can be dispersed or dissolved in an aqueous medium without a dispersant. Here, “dispersed or dissolved in an aqueous medium without a dispersant” refers to a state in which a pigment is stably present in an aqueous medium due to a hydrophilic group on the surface of the pigment even when a dispersant for dispersing the pigment is not used. Thus, there is almost no foaming due to a decrease in defoaming properties caused by the dispersant, and an ink having excellent ejection stability is easily prepared. In addition, since a significant increase in viscosity due to the dispersant is inhibited, the pigment can be contained in a larger amount, and printing density can be sufficiently increased, thus making handling easy.

Examples of the hydrophilic group include —OM, —COOM, —CO—, —SO₃M, —SO₂M, —SO₂NH₂, —RSO₂M, —PO₃HM, —PO₃M₂, —SO₂NHCOR, —NH₃, and —NR₃.

In these chemical formulae, M represents a hydrogen atom, an alkali metal, ammonium, a phenyl group optionally having a substituent, or an organic ammonium, and R represents an alkyl group having 1 to 12 carbon atoms or a naphthyl group optionally having a substituent. M and R above are each selected independently of one another.

The self-dispersed pigment is produced by, for example, subjecting a pigment to physical treatment or chemical treatment to bond (graft) the hydrophilic group to the surface of the pigment. Examples of the physical treatment include a vacuum plasma treatment. Examples of the chemical treatment include the wet oxidation method, in which oxidation is performed with an oxidizing agent in water, and a method in which p-aminobenzoic acid is bonded to the surface of the pigment to bond a carboxy group via a phenyl group.

The polymer-dispersed pigment is a pigment that can be dispersed by polymer dispersion. The polymer for use in the polymer-dispersed pigment is not limited to the following, but, for example, the glass transition temperature (Tg) of the dispersion polymer used for dispersing the pigment is preferably 55° C. or lower, and more preferably 50° C. or lower. When Tg is 55° C. or lower, the fixability of the ink can be made good in some cases.

The weight average molecular weight of the polymer measured by gel permeation chromatography (GPC) is preferably 10,000 or more and 200,000 or less. This can make the storage stability of the ink better in some cases. Here, the weight average molecular weight (Mw) in the present specification can be measured as a weight average molecular weight in terms of polystyrene using gel permeation chromatography (GPC) of the L7100 system manufactured by Hitachi, Ltd.

As the polymer, since the fixability and glossiness of the ink tend to be more excellent, a polymer in which 70% by mass or more of its constituent components is obtained by copolymerization of (meth)acrylate and (meth)acrylic acid is preferable. The polymer is preferably obtained by polymerization from monomer components in which at least one of an alkyl (meth)acrylate having 1 to 24 carbon atoms or a cyclic alkyl (meth)acrylate having 3 to 24 carbon atoms is contained in an amount of 70% by mass or more. Specific examples of the monomer component include, but are not limited to, methyl (meth)acrylate, ethyl (meth)acrylate, propyl (meth)acrylate, n-butyl (meth)acrylate, isobutyl (meth)acrylate, pentyl (meth)acrylate, hexyl (meth)acrylate, 2-ethylhexyl (meth)acrylate, octyl (meth)acrylate, nonyl (meth)acrylate, decyl (meth)acrylate, t-butylcyclohexyl (meth)acrylate, lauryl (meth)acrylate, isobornyl (meth)acrylate, cetyl (meth)acrylate, stearyl (meth)acrylate, isostearyl (meth)acrylate, tetramethylpiperidyl (meth)acrylate, dicyclopentanyl (meth)acrylate, dicyclopentenyl (meth)acrylate, dicyclopentenyloxy (meth)acrylate, and behenyl (meth)acrylate. In addition, as other monomer components for polymerization, hydroxy (meth)acrylates having a hydroxy group, such as hydroxyethyl (meth)acrylate, hydroxypropyl (meth)acrylate, and diethylene glycol (meth)acrylate, urethane (meth)acrylate, and epoxy (meth)acrylate can also be used.

Since the fixability, glossiness, and color reproducibility of the ink tend to be excellent, a pigment coated with a polymer (polymer-coated pigment), that is, a microencapsulated pigment, may be suitably used among the polymer-dispersed pigments.

The polymer-coated pigment is obtained by phase inversion emulsification. That is, the above polymer is dissolved in an organic solvent such as methanol, ethanol, isopropanol, n-butanol, acetone, methyl ethyl ketone, or dibutyl ether. A pigment is added to the obtained solution, and then a neutralizing agent and water are added thereto, followed by performing kneading and dispersion treatment to prepare an oil-in-water type dispersion. By removing the organic solvent from the obtained dispersion, the polymer-coated pigment can be obtained as an aqueous dispersion. In the kneading and dispersion treatment, for example, a ball mill, a roll mill, a bead mill, a high-pressure homogenizer, a high-speed stirring type dispersing machine, or the like can be used.

Preferable examples of the neutralizing agent include tertiary amines such as ethylamine and trimethylamine, lithium hydroxide, sodium hydroxide, potassium hydroxide, and ammonia. The pH of the resulting aqueous dispersion is preferably 6 to 10.

As the polymer for coating the pigment, a polymer having a weight average molecular weight measured by GPC of about 10,000 to 150,000 is preferable in that the pigment is stably dispersed.

The content of the pigment (solid content) is, for example, preferably 0.1% by mass or more, more preferably 0.5% by mass or more, even more preferably 18 by mass or more, and particularly preferably 1.5% by mass or more with respect to the total amount of the ink composition. In addition, the content of the pigment (solid content) is preferably 10% by mass or less, more preferably 5% by mass or less, and even more preferably 38 by mass or less with respect to the total amount of the ink composition. When the content of the pigment is within the above range, clogging recoverability may be more excellent.

The ink jet ink composition according to the present embodiment may contain a dye as a coloring material other than the pigment. The dye is not particularly limited, and an acid dye, a direct dye, a reactive dye, and a basic dye can be used. Examples of the dye include C.I. Acid Yellow 17, 23, 42, 44, 79, and 142; C.I. Acid Red 52, 80, 82, 249, 254, and 289; C.I. Acid Blue 9, 45, and 249; C.I. Acid Black 1, 2, 24, and 94; C.I. Food Black 1 and 2; C.I. Direct Yellow 1, 12, 24, 33, 50, 55, 58, 86, 132, 142, 144, and 173; C.I. Direct Red 1, 4, 9, 80, 81, 225, and 227; C.I. Direct Blue 1, 2, 15, 71, 86, 87, 98, 165, 199, and 202; C.I. Direct Black 19, 38, 51, 71, 154, 168, 171, and 195; C.I. Reactive Red 14, 32, 55, 79, and 249; and C.I. Reactive Black 3, 4, and 35.

### 1.2 Resin Particles

The ink jet ink composition according to the present embodiment contains resin particles. The resin particles function as what is called a fixing resin that improves the adhesion and abrasion resistance of the components of the ink caused to adhere to the recording medium. The resin particles may be in powder form, but is preferably in emulsion form.

Examples of the resin of the resin particles include resins such as urethane-based resins, acrylic-based resins, fluorene-based resins, polyolefin-based resins, rosin-modified resins, terpene-based resins, polyester-based resins, polyamide-based resins, epoxy-based resins, vinyl chloride-based resins, ethylene-vinyl acetate-based resins, vinyl acetate resins, butadiene resins, styrene resins, cross-linked acrylic resins, cross-linked styrene resins, benzoguanamine resins, phenolic resins, silicone resins, epoxy resins, paraffin resins, and fluororesins.

“Urethane-based resin” is a generic term for resins having a urethane bond. As the urethane-based resin, a polyether-type urethane resin including an ether bond in the main chain in addition to a urethane bond, a polyester-type urethane resin including an ester bond in the main chain in addition to a urethane bond, a polycarbonate-type urethane resin including a carbonate bond in the main chain in addition to a urethane bond, and the like may be used. As the urethane-based resin, commercially available products may be used, and it may be selected from, for example, Superflex 210, 460, 460s, 840, and E-4000 (product names, manufactured by DKS Co. Ltd.), Resamine D-1060, D-2020, D-4080, D-4200, D-6300, and D-6455 (product names, manufactured by Dainichiseika Colour & Chemicals Mfg. Co., Ltd.), Takelac WS-6020, WS-6021, and W-512-A-6 (product names, manufactured by Mitsui Chemical Polyurethane, Inc.), Sancure 2710 (a product name, manufactured by Lubrizol Corporation), Permarin UA-150 (a product name, manufactured by Sanyo Chemical Industries, Ltd.), and the like.

“Acrylic-based resin” is a generic term for polymers obtained by polymerizing at least an acrylic monomer such as (meth)acrylic acid or (meth)acrylate as one component, and examples thereof include resins obtained from an acrylic monomer and copolymers of an acrylic monomer and other monomers. Examples thereof include acrylic-vinyl-based resins, which are copolymers of an acrylic monomer and a vinyl-based monomer. Examples thereof further include copolymers with a vinyl-based monomer such as styrene. As the acrylic monomer, acrylamide, acrylonitrile, and the like can also be used.

As the acrylic-based resin, commercially available products may be used, and it may be selected from, for example, FK-854 (a product name, manufactured by Chuo Rika Kogyo Corporation), Mowinyl 952B and 718A (product names, manufactured by The Nippon Synthetic Chemical Industry Co., Ltd.), Nipol LX852 and LX874 (product names, Zeon Corporation), Polysol AT860 (manufactured by Showa Denko K.K.), Voncoat AN-1190S, YG-651, AC-501, AN-1170, and 4001 (product names, manufactured by DIC Corporation, acrylic-based resin emulsions), and the like.

In the present specification, the acrylic-based resin may be a styrene-acrylic-based resin as described above.

The styrene-acrylic-based resin is a copolymer obtained from a styrene monomer and an acrylic monomer, and examples thereof include styrene-acrylic acid copolymers, styrene-methacrylic acid copolymers, styrene-methacrylic acid-acrylate copolymers, styrene-α-methylstyrene-acrylic acid copolymers, and styrene-α-methylstyrene-acrylic acid-acrylate copolymers. As the styrene-acrylic-based resin, commercially available products may be used, and examples thereof include Joncryl 62J, 7100, 390, 711, 511, 7001, 631, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (product names, manufactured by BASF) and Mowinyl 966A and 975N (product names, manufactured by The Nippon Synthetic Chemical Industry Co., Ltd.).

The vinyl chloride-based resin may be a vinyl chloride-vinyl acetate copolymer.

The polyolefin-based resin has an olefin such as ethylene, propylene, or butylene in the structural skeleton, and known ones can be selected as appropriate and used. As the polyolefin-based resin, commercially available products can be used, and it may be selected from, for example, Arrowbase CB-1200 and CD-1200 (product names, manufactured by Unitika Ltd.), Hitec E-6500 (a product name, manufactured by Toho Chemical Industry Co., Ltd., a polyethylene wax emulsion), SN-2002 (a product name, manufactured by Toho Chemical Industry Co., Ltd., a polyester resin emulsion), and the like.

Examples of commercially available resin emulsions may be selected from Microgel E-1002 and E-5002 (product names, manufactured by Nippon Paint Co., Ltd., styrene-acrylic-based resin emulsions), Voncoat AN-1190S, YG-651, AC-501, AN-1170, 4001, and 5454 (product names, manufactured by DIC Corporation, styrene-acrylic-based resin emulsions), Polysol AM-710, AM-920, AM-2300, AP-4735, AT-860, and PSASE 4210E (acrylic-based resin emulsions), Polysol AP-7020 (a styrene-acrylic resin emulsion), Polysol SH-502 (a vinyl acetate resin emulsion), Polysol AD-13, AD-2, AD-10, AD-96, AD-17, and AD-70 (ethylene-vinyl acetate resin emulsions), Polysol PSASE-6010 (an ethylene-vinyl acetate emulsion) (product names, manufactured by Showa Denko K.K.), Polysol SAE1014 (a product name, a styrene-acrylic-based resin emulsion, manufactured by Zeon Corporation), Cyvinol SK-200 (a product name, an acrylic-based resin emulsion, manufactured by Saiden Chemical Industry Co., Ltd.), AE-120A (a product name, manufactured by JSR Corporation, an acrylic resin emulsion), AE373D (a product name, manufactured by Emulsion Technology Co., Ltd., a carboxy-modified styrene-acrylic resin emulsion), Seikadyne 1900W (a product name, manufactured by Dainichiseika Colour & Chemicals Mfg. Co., Ltd., an ethylene-vinyl acetate resin emulsion), Vinyblan 2682 (an acrylic resin emulsion), Vinyblan 2886 (a vinyl acetate acrylic resin emulsion), Vinyblan 5202 (an acrylic acetate resin emulsion) (product names, manufactured by Nissin Chemical Co., Ltd.), Vinyblan 700 and 2586 (manufactured by Nissin Chemical Co., Ltd.), Elitel KA-5071S, KT-8803, KT-9204, KT-8701, KT-8904, and KT-0507 (product names, manufactured by Unitika Ltd., polyester resin emulsions), Hitec E-6500 (a product name, manufactured by Toho Chemical Industry Co., Ltd., a polyethylene wax emulsion), SN-2002 (a product name, manufactured by Toho Chemical Industry Co., Ltd., a polyester resin emulsion), Takelac W-6020, W-635, W-6061, W-605, W-635, and W-6021 (product names, manufactured by Mitsui Chemical Polyurethane, Inc., urethane-based resin emulsions), Superflex 870, 800, 150, 420, 460, 470, 610, 620, and 700 (product names, manufactured by DKS Co. Ltd., urethane-based resin emulsions), Permarin UA-150 (manufactured by Sanyo Chemical Industries, Ltd., a urethane-based resin emulsion), Sancure 2710 (manufactured by Lubrizol Japan Limited, a urethane-based resin emulsion), NeoRez R-9660, R-9637, and R-940 (manufactured by Kusumoto Chemicals, Ltd., urethane-based resin emulsions), Adeka Bontiter HUX-380 and 290K (manufactured by ADEKA Corporation, urethane-based resin emulsions), Mowinyl 966A and Mowinyl 7320 (manufactured by The Nippon Synthetic Chemical Industry Co., Ltd.), Joncryl 7100, 390, 711, 511, 7001, 631, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (the above are manufactured by BASF), NK Binder R-5HN (manufactured by Shin-Nakamura Chemical Co., Ltd.), Hydran WLS 210 (a non-cross-linked polyurethane, manufactured by DIC Corporation), and the like.

Among these resins, the acrylic-based resin and the polyolefin-based resin are preferable, and a combination of the acrylic-based resin and the polyolefin-based resin is more preferable. Such a resin tends to make clogging recoverability more excellent.

The glass transition temperature (Tg) of the resin particles is preferably 60° C. or higher, more preferably 70° C. or higher, even more preferably 80° C. or higher, and particularly preferably 90° C. or higher. On the other hand, the glass transition temperature is preferably 120° C. or lower, more preferably 115° C. or lower, even more preferably 110° C. or lower, and particularly preferably 105° C. or lower. When the glass transition temperature (Tg) of the resin particles is within the above range, clogging recoverability can be more excellent in some cases. Note that the glass transition temperature (Tg) of the resin particles can be determined by a common method using differential scanning calorimetry (DSC) or the like.

The content of the resin particles (solid content) is preferably 0.5% by mass or more, more preferably 18 by mass or more, even more preferably 2% by mass or more, and particularly preferably 3% by mass or more with respect to the total amount of the ink composition. In addition, the content of the resin particles (solid content) is preferably 20% by mass or less, more preferably 15% by mass or less, even more preferably 10% by mass or less, and particularly preferably 7% by mass or less with respect to the total amount of the ink composition.

### 1.3 Surfactant

The ink jet ink composition according to the present embodiment contains a surfactant. The surfactant contains a silicone-based surfactant and an acetylene glycol-based surfactant having an HLB value of 9 to 14.

The total content of the acetylene glycol-based surfactant having an HLB value of 9 to 14 and the silicone-based surfactant is preferably 0.1 to 18 by mass with respect to the total amount of the ink composition. When the total content is within the above range, there is a tendency that the balance between clogging recoverability and image quality is excellent, and both clogging recoverability and image quality can be good. The lower limit of the total content is more preferably 0.2% by mass or more, even more preferably 0.3% by mass or more, particularly preferably 0.4% by mass or more, and more particularly preferably 0.5% by mass or more with respect to the total amount of the ink composition. In addition, the upper limit of the total content is preferably 0.9% by mass or less, more preferably 0.8% by mass or less, and particularly preferably 0.7% by mass or less with respect to the total amount of the ink composition. When the total content of the surfactants is within or less than the above range, it is possible to inhibit destabilization of the dispersion of the pigment or the resin due to phase separation in the ink, which is preferable.

The ratio of the content of the silicone-based surfactant to the content of the acetylene glycol-based surfactant having an HLB value of 9 to 14 (the content of the silicone-based surfactant/the content of the acetylene glycol-based surfactant having an HLB value of 9 to 14) is preferably 0.5 to 4, more preferably 1 to 3.5, even more preferably greater than 1 to 3.0, and still even more preferably 1.5 to 2.5. Since the function of the acetylene glycol-based surfactant is mainly to ensure clogging recoverability and has less contribution to improvement in image quality, the content of the silicone-based surfactant is preferably larger than the content of the acetylene glycol-based surfactant from the viewpoint of making image quality better.

### 1.3.1 Acetylene Glycol-Based Surfactant

The surfactant includes an acetylene glycol-based surfactant having an HLB value of 9 to 14. The acetylene glycol-based surfactant is excellent in compatibility with the poorly water-soluble low-molecular-weight organic compound and has a property of being less likely to be hydrolyzed even when the pH is closer to alkalinity.

In the present specification, the “HLB value” (value of hydrophile and liophile balance) is a numerical representation of the hydrophilic-hydrophobic balance of a compound. Here, the HLB value is a value calculated by the Griffin method and can be determined by Equation (H) below:

HLB value=20×sum of formula weights of hydrophilic portions/molecular weight (H)

The lower limit of the HLB value of the acetylene glycol-based surfactant is 9 or more, and is preferably 10 or more, more preferably 11 or more, even more preferably 12 or more, and particularly preferably 13 or more. When the HLB value is lower than 9, the water solubility of the acetylene glycol-based surfactant is poor, the acetylene glycol-based surfactant easily forms foreign matter, and the dispersion stability of the pigment and the like rather deteriorates.

The upper limit of the HLB value of the acetylene glycol-based surfactant is 14 or less. When the HLB value is higher than 14, compatibility with the poorly water-soluble low-molecular-weight organic compound cannot be obtained.

Examples of the acetylene glycol-based surfactant having an HLB value of 9 to 14 include Olfine E1010 (HLB value: 13 to 14), Olfine EXP.4200 (HLB value: 10 to 13), and Olfine EXP. 4123 (HLB value: 10 to 13) [product names, manufactured by Nissin Chemical Co., Ltd.].

The content of the acetylene glycol-based surfactant having an HLB value of 9 to 14 is preferably 0.05 to 0.5% by mass, more preferably 0.1 to 0.4% by mass, and even more preferably 0.15 to 0.3% by mass with respect to the total amount of the ink composition. When the content of the acetylene glycol-based surfactant having an HLB value of 9 to 14 is within the above range, clogging recoverability tends to be more excellent.

### 1.3.2 Silicone-Based Surfactant

The surfactant contains a silicone-based surfactant. The silicone-based surfactant has an excellent function of improving wetting and spreading of the water-based ink against the low- or non-absorbent recording medium, and excellent image quality can be obtained by incorporating it in the ink together with the poorly water-soluble low-molecular-weight organic compound. Note that sufficient wetting and spreading of the ink cannot be ensured with the acetylene glycol-based surfactant alone.

The silicone-based surfactant is not particularly limited, and examples thereof preferably include polysiloxane-based compounds. The polysiloxane-based compounds are not particularly limited, and examples thereof include polyether-modified organosiloxanes. Examples of commercially available products of the polyether-modified organosiloxanes include BYK-306, BYK-307, BYK-333, BYK-341, BYK-345, BYK-346, BYK-348, BYK-349, and BYK 3420 (product names, manufactured by BYK-Chemie Japan K.K.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF 6017 (product names, manufactured by Shin-Etsu Chemical Co., Ltd.), Silface SAG503A and Silface SAG014 (product names, manufactured by Nissin Chemical Co., Ltd.), and TEGO wet 270 (a product name, manufactured by Evonik Industries).

The silicone-based surfactant preferably has a cloud point of 40° C. or higher. When the cloud point is 40° C. or higher, there is a tendency that solubility in water is excellent, and clogging recoverability is more excellent. The lower limit of the cloud point is more preferably 45° C. or higher, and even more preferably 50° C. or higher. The upper limit of the cloud point is not particularly limited, and is, for example, preferably 100° C. or lower, more preferably 80° C. or lower, and even more preferably 60° C. or lower.

A method for measuring the cloud point is performed, for example, as follows. First, a solution obtained by mixing the silicone-based surfactant, propylene glycol, and water in a mass ratio of 1:9:90 is stirred for 30 minutes or more. Subsequently, 20 g of the mixed solution is put into a 30 mL sample bottle, and is left to stand in a thermostatic bath at a predetermined temperature for one day. If the mixed solution is visually observed to be in a mixed state (the liquid is transparent) after being left to stand for one day, it can be determined that the silicone-based surfactant has a cloud point equal to or higher than the predetermined temperature. On the other hand, in the case of a cloudy state or a state in which a separated substance is present, it can be determined that the silicone-based surfactant does not have a cloud point equal to or higher than the predetermined temperature.

The content of the silicone-based surfactant is preferably 0.1 to 1.0% by mass, more preferably 0.2 to 0.8% by mass, and even more preferably 0.3 to 0.5% by mass with respect to the total amount of the ink composition. When the content of the silicone-based surfactant is within the above range, image quality tends to be more excellent.

### 1.3.3 Other Surfactants

The surfactant may contain a surfactant other than those described above. Examples of the other surfactant include acetylene glycol-based surfactants having an HLB value of less than 9 or greater than 14 and fluorine-based surfactants.

As the fluorine-based surfactants, a fluorine-modified polymer is preferably used, and specific examples thereof include BYK-340 (a product name, manufactured by BYK Japan K.K.).

### 1.4 Poorly Water-Soluble Low-Molecular-Weight Organic Compound

The ink jet ink composition according to the present embodiment contains a poorly water-soluble low-molecular-weight organic compound that is either an alkanediol or a glycol ether and that has a solubility in water of 10 g/100 g of water or less. The poorly water-soluble low-molecular-weight organic compound has relatively high hydrophobicity. Therefore, the ink containing this has high affinity with the low- or non-absorbent recording medium, and the ink tends to easily wet and spread.

The upper limit of the solubility in water of the poorly water-soluble low-molecular-weight organic compound is 10 g/100 g of water or less, and is preferably 8 g/100 g of water or less, more preferably 6 g/100 g of water or less, even more preferably 4 g/100 g of water or less, particularly preferably 2 g/100 g of water or less, and more particularly preferably 1 g/100 g of water or less.

The lower limit of the solubility in water of the poorly water-soluble low-molecular-weight organic compound is not particularly limited, and may be 0 g/100 g of water or more, 0.01 g/100 g of water or more, 0.1 g/100 g of water or more, 0.5 g/100 g of water or more, or 0.7 g/100 g of water or more.

The solubility in water of the poorly water-soluble low-molecular-weight organic compound is determined by, for example, the following method. First, under an environment of 20° C., a predetermined amount of the compound is mixed with 100 g of water, and the mixture is stirred for 30 minutes. A compound that is liquid at room temperature is determined to be dissolved when there is no phase separation or sea-island structure after stirring. A compound that is solid at normal temperature is determined to be dissolved when there is no undissolved residue.

In this way, when predetermined amounts of the compound are mixed with 100 g of water, the largest predetermined amount among predetermined amounts for which the compound is determined to be dissolved is determined as the solubility.

In the present disclosure, “low-molecular-weight” refers to having a molecular weight of 300 or less.

The upper limit of the molecular weight of the poorly water-soluble low-molecular-weight organic compound is 300 or less, preferably 250 or less, and more preferably 200 or less. The lower limit of the molecular weight is not limited, and is, for example, preferably 50 or more, and more preferably 100 or more.

The normal boiling point of the poorly water-soluble low-molecular-weight organic compound is not particularly limited, and is preferably 300° C. or lower, more preferably 280° C. or lower, and even more preferably 270° C. or lower. The lower limit of the normal boiling point is not particularly limited, and is preferably 100° C. or higher, more preferably 150° C. or higher, even more preferably 200° C. or higher, and particularly preferably 250° C. or higher.

The melting point of the poorly water-soluble low-molecular-weight organic compound is preferably 130° C. or lower. In addition, the melting point is preferably −120° C. or higher. Further, the melting point is preferably −50 to 60° C., and more preferably-30 to 50° C.

Examples of the poorly water-soluble low-molecular-weight organic compound include organic solvents (liquid at room temperature) and compounds that are solid at room temperature.

The content of the poorly water-soluble low-molecular-weight organic compound that is either an alkanediol or a glycol ether and that has a solubility in water of 10 g/100 g of water or less is preferably 0.1 to 2% by mass with respect to the total amount of the ink composition. The lower limit of the content is preferably 0.18 by mass or more, more preferably 0.2% by mass or more, even more preferably 0.3% by mass or more, and particularly preferably 0.4% by mass or more with respect to the total amount of the ink composition from the viewpoint that image quality tends to be more excellent. The upper limit of the content is preferably 2% by mass or less, more preferably 1.5% by mass or less, even more preferably 1.0% by mass or less, particularly preferably 0.8% by mass or less, and more particularly preferably 0.6% by mass or less from the viewpoint that clogging recoverability tends to be more excellent.

### 1.4.1 Alkanediols

The ink jet ink composition according to the present embodiment preferably contains a poorly water-soluble low-molecular-weight organic compound that is an alkanediol and that has a solubility in water of 10 g/100 g of water or less. The poorly water-soluble low-molecular-weight organic compound that is an alkanediol tends to make the ink more likely to wet and spread on the recording medium and to make image quality more excellent. Further, since foreign matter is unlikely to form when the ink is dried, clogging recoverability tends to be more excellent.

Examples of the alkanediol that is the poorly water-soluble low-molecular-weight organic compound include aliphatic diols and alicyclic diols. Examples of aliphatic diols include 1,3-alkanediols and aliphatic diols other than 1,3-alkanediols.

Examples of aliphatic diols include aliphatic diols having 6 or more carbon atoms, and further examples thereof include aliphatic diols having 8 to 20 carbon atoms.

Examples of 1,3-alkanediols include 2,2-diethyl-1,3-propanediol (DEPOD, normal boiling point: 240° C., solid at 25° C., solubility: 10.0 [g/100 g of water]), 2-methyl-2-propyl-1,3-propanediol (MPPD, normal boiling point: 230° C., melting point: 57° C., solubility: 7.5 [g/100 g of water]), 2-butyl-2-ethyl-1,3-propanediol (BEPG, normal boiling point: 264° C., melting point: 41° C., solubility: 0.9 [g/100 g of water]), 2,2-diisobutyl-1,3-propanediol (DIBPD, normal boiling point: 253° C., melting point: 77° C., solubility: 0.5 [g/100 g of water]), 2,2-dibutyl-1,3-propanediol (DBPD, normal boiling point: 269° C., solubility: 0.2 [g/100 g of water]), 2,2,4-trimethyl-1,3-pentanediol (TMPD, normal boiling point: 232° C., melting point: 54° C., solubility: 1.9 [g/100 g of water]), and 2-ethyl-1,3-hexanediol (EHD, normal boiling point: 244° C., melting point: −40° C., solubility: 4.2 [g/100 g of water]).

Examples of aliphatic diols other than 1,3-alkanediols include 1,2-octanediol (1,2OD, normal boiling point: 267° C., melting point: 28° C., solubility: 0.3 [g/100 g of water]), 1,9-nonanediol (1,9ND, normal boiling point: 289° C., melting point: 46° C., solubility: 0.6 [g/100 g of water]), 1,2-decanediol (normal boiling point: 279° C., melting point: 49° C., solubility: 0.1 [g/100 g of water]), and 2,4-diethyl-1,5-pentanediol (DEPD, normal boiling point: 257° C., liquid (25° C.), solubility: 1.0 [g/100 g of water]).

Examples of alicyclic diols include 2,2,4,4-tetramethyl-1,3-cyclobutanediol (TMCD; normal boiling point: 220° C., melting point: 126° C., solubility: 6.1 [g/100 g of water]), and 1,4-cyclohexane dimethanol (CHDM; normal boiling point: 286° C., melting point: 35° C.; solubility: 0.8 [g/100 g of water]).

Examples of the alicyclic structure of alicyclic diols include alicyclic diols having an aliphatic ring having 4 to 10 carbon atoms.

Examples of the number of carbon atoms in the molecule of alicyclic diols include those similar to the number of carbon atoms of the above aliphatic diols.

Among these, the alkanediol is preferably one or more selected from 2-butyl-2-ethyl-1,3-propanediol (BEPG) and 1,2-octanediol (1,2OD) from the viewpoint that image quality (wetting and spreading) and clogging recoverability tend to be more excellent.

Among the above 1,3-alkanediols, a 1,3-alkanediol represented by General Formula (1) below is preferable from the viewpoint that image quality and clogging recoverability tend to be more excellent.

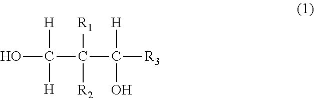

where R₁, R₂, and R₃ are each independently a hydrogen atom or an alkyl group; and the total number of carbon atoms of R₁, R₂ and R₃ is 3 to 9.

Further, in the above formula, R₁ and R₂ are preferably not simultaneously a hydrogen atom. When R₁, R₂, and R₃ are alkyl groups, the alkyl groups independently preferably have 1 to 5 carbon atoms, and more preferably have 2 to 4 carbon atoms. The total number of carbon atoms of R₁, R₂ and R₃ is preferably 4 to 6, and more preferably 4 or 5. R₃ is preferably an alkyl group.

Examples of the 1,3-alkanediol represented by General Formula (1) above include 2-methyl-2-propyl-1,3-propanediol (MPPD), 2-butyl-2-ethyl-1,3-propanediol (BEPG), 2,2,4-trimethyl-1,3-pentanediol (TMPD), and 2-ethyl-1,3-hexanediol (EHD), with 2-butyl-2-ethyl-1,3-propanediol (BEPG) being preferable.

### 1.4.2 Glycol Ethers

Examples of the poorly water-soluble low-molecular-weight organic compound that is a glycol ether and that has a solubility in water of 10 g/100 g of water or less include glycol monoethers and glycol diethers.

Examples of the above glycol monoethers include ethylene glycol monohexyl ether (EGHE, boiling point: 208° C., melting point: −45° C., solubility: 1.0 [g/100 g of water]), ethylene glycol mono-2-ethylhexyl ether (EHG, boiling point: 229° C., melting point: −105° C., solubility: 0.1 [g/100 g of water]), diethylene glycol monohexyl ether (HDG, boiling point: 259° C., liquid (25° C.), solubility: 1.7 [g/100 g of water]), diethylene glycol mono-2-ethylhexyl ether (EHDG, boiling point: 277° C., melting point: −82° C., solubility: 0.5 [g/100 g of water], alternative name: 2-ethylhexyl diglycol), dipropylene glycol monobutyl ether (BPDG, boiling point: 230° C., liquid (25° C.), solubility: 4.0 [g/100 g of water]), and tripropylene glycol monobutyl ether (BPTG, boiling point: 276° C., solubility: 4.0 [g/100 g of water]).

Examples of the above glycol diethers include diethylene glycol butyl methyl ether (BMTG, boiling point: 212° C., liquid (25° C.)) and diethylene glycol dibutyl ether (DBDG, boiling point: 256° C., melting point: −60° C., solubility: 0.3 g/100 g of water).

Among these glycol ethers, the glycol ether is preferably a glycol ether having 6 or more carbon atoms. Examples of the glycol ether having 6 or more carbon atoms include ethylene glycol monohexyl ether (EGHE), ethylene glycol mono-2-ethylhexyl ether (EHG), diethylene glycol monohexyl ether (HDG), diethylene glycol mono-2-ethylhexyl ether (EHDG), dipropylene glycol monobutyl ether (BPDG), tripropylene glycol monobutyl ether (BPTG), diethylene glycol butyl methyl ether (BMTG), and diethylene glycol dibutyl ether (DBDG).

### 1.5 Water

The ink jet ink composition according to the present embodiment is a water-based composition. The water-based composition is a composition containing at least water as a solvent component of the composition.

The content of water in a liquid medium component is preferably 30 to 100% by mass, more preferably 40 to 90% by mass, and even more preferably 50 to 80% by mass. Note that the liquid medium is a solvent component such as water or a water-soluble low-molecular-weight organic compound.

The content of water is preferably 40% by mass or more, more preferably 45% by mass or more, even more preferably 50% by mass or more, and particularly preferably 60% by mass or more with respect to the total amount of the ink composition. The upper limit of the content of water is not particularly limited, and is, for example, preferably 99% by mass or less or 90% by mass or less, more preferably 85% by mass or less, and even more preferably 80% by mass or less with respect to the total amount of the ink composition.

Examples of water include water in which ionic impurities are reduced, such as pure water such as ion exchange water, ultrafiltered water, reverse osmosis water, and distilled water, and ultrapure water. In addition, when water sterilized by ultraviolet irradiation, addition of hydrogen peroxide, or the like is used, the generation of bacteria or fungi can be inhibited when the ink jet ink composition is stored for a long period of time.

### 1.6 Water-Soluble Low-Molecular-Weight Organic Compound

The ink jet ink composition according to the present embodiment may contain a water-soluble low-molecular-weight organic compound. The water-soluble low-molecular-weight organic compound has a property of improving the water solubility of the above poorly water-soluble low-molecular-weight organic compound. When the ink contains the water-soluble low-molecular-weight organic compound, there is a tendency that the above poorly water-soluble low-molecular-weight organic compound is inhibited from forming foreign matter, and clogging recoverability can be more excellent. Examples of the water-soluble low-molecular-weight organic compound include compounds that are liquid at normal temperature and ones that are solid at normal temperature.

“Water-soluble” in the context of the water-soluble low-molecular-weight organic compound refers to its solubility in water at 20° C. exceeding 10 g/100 g of water. The solubility in water at 20° C. of the water-soluble low-molecular-weight organic compound is preferably 11 g/100 g of water or more, and more preferably 50 g/100 g of water or more. The upper limit thereof is not limited, and may be infinite. Note that the solubility of the water-soluble low-molecular-weight organic compound can be determined in the same manner as the method described above.

“Low-molecular-weight” in the context of the water-soluble low-molecular-weight organic compound is as described above, and refers to having a molecular weight of 300 or less. The upper limit of the molecular weight of the water-soluble low-molecular-weight organic compound is preferably 250 or less, and more preferably 200 or less. The lower limit thereof is not particularly limited, and is preferably 50 or more.

The water-soluble low-molecular-weight organic compound is preferably a compound completely miscible with water or a compound miscible with water. Here, “completely miscible with water” refers to a case in which water and an organic compound are dissolved with each other, that is, a case in which the solubility of the organic compound in 100 g of water at 20° C. is infinite. “Miscible with water” refers to a case in which water and an organic compound have limited solubility, that is, a case in which at least the solubility of the organic compound in 100 g of water at 20° C. is greater than 10 g.

The water-soluble low-molecular-weight organic compound preferably contains one having a normal boiling point of 150 to 350° C., and the normal boiling point is more preferably 150 to 320° C. The water-soluble low-molecular-weight organic compound preferably contains a compound having a melting point of 90° C. or lower, and more preferably contains a compound having a melting point of 80° C. or lower. The lower limit of the melting point is not particularly limited, and is preferably −70° C. or higher.

Examples of the water-soluble low-molecular-weight organic compound include resin-dissolving substances, polyols, glycol ethers, and alkanolamines. If necessary, other water-soluble low-molecular-weight organic compounds may be contained.

Among these, the water-soluble low-molecular-weight organic compound is preferably a resin-dissolving substance, a polyol, or an alkanolamine. More preferably, the water-soluble low-molecular-weight organic compound is a resin-dissolving substance or an alkanolamine having a normal boiling point of higher than 250° C., the resin-dissolving substance being any of an amide, a sulfur-containing solvent, and a cyclic ether, or a polyol having a normal boiling point of 250° C. or lower.

The ink jet ink composition according to the present embodiment preferably contains the water-soluble low-molecular-weight organic compound in an amount of 50% by mass or less, more preferably 40% by mass or less, and even more preferably 30% by mass or less with respect to the total amount of the ink composition. As the lower limit value thereof, the jet ink composition according to the present embodiment preferably contains the water-soluble low-molecular-weight organic compound in an amount of 5% by mass or more, more preferably 108 by mass or more, and even more preferably 15% by mass or more with respect to the total amount of the ink composition.

When the water-soluble low-molecular-weight organic compound is contained within the above range, there is a tendency that the compatibility between the water-soluble low-molecular-weight organic compound and the poorly water-soluble low-molecular-weight organic compound becomes better, and clogging recoverability is more excellent.

### 1.6.1 Resin-Dissolving Substance

Examples of the resin-dissolving substance include amides, sulfur-containing solvents, and cyclic ethers. In particular, from the viewpoint of being able to further improve the abrasion resistance of recorded matter, it is preferable to contain any of an amide, a sulfur-containing solvent, and a cyclic ether having a normal boiling point of higher than 250° C., and it is more preferable to contain an amide having a normal boiling point of higher than 250° C. The resin-dissolving substance is an organic compound having the function of dissolving a resin to improve abrasion resistance, but is not limited to this function.

### Amides

Examples of amides include cyclic amides (lactams) such as 2-pyrrolidone (2P), 2-piperidone, ε-caprolactam (CPL, normal boiling point: 267° C., solid (25° C.))N-methyl-ε-caprolactam, N-cyclohexyl-2-pyrrolidone, N-methylpyrrolidone, N-ethylpyrrolidone, N-butylpyrrolidone, 5-methyl-2-pyrrolidone, β-propiolactam, and ω-heptalactam, and chain amides such as N,N-dimethylacetoacetamide, N,N-diethylacetoacetamide, N-methylacetoacetamide, N,N-dimethylisobutyramide, N,N-dimethylformamide, N,N-diethylformamide, N,N-dimethylacetamide, N,N-diethylacetamide, N,N-dimethylpropionamide, 3-methoxy-N,N-dimethylpropanamide (DMPA), 3-n-butoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-iso-propoxy-N,N-dimethylpropionamide, 3-iso-propoxy-N,N-diethylpropionamide, 3-iso-propoxy-N,N-methylethylpropionamide, 3-tert-butoxy-N,N-dimethylpropionamide, 3-tert-butoxy-N,N-diethylpropionamide, and 3-tert-butoxy-N,N-methylethylpropionamide.

Among these, from the viewpoint of being able to further improve the abrasion resistance of recorded matter, any of 2-pyrrolidone (2P), ε-caprolactam (CPL), and 3-methoxy-N,N-dimethylpropanamide (DMPA) is preferable, and ε-caprolactam (CPL) is more preferable.

### Sulfur-Containing Solvent

Examples of the sulfur-containing solvent include 3-methylsulfolane, sulfolane, ethyl isopropyl sulfone, ethyl methyl sulfone, dimethyl sulfone, dimethyl sulfoxide (DMSO), diethyl sulfoxide, tetramethylene sulfoxide, and methylphenyl sulfoxide.

Among these, from the viewpoint of being able to further improve the abrasion resistance of recorded matter, dimethyl sulfoxide (DMSO) is more preferable.

### Cyclic Ethers

Examples of cyclic ethers include isosorbide dimethyl ether, 3-methyl-3-oxetanemethanol, 3-ethyl-3-oxetanemethanol (DMHD), 2-hydroxymethyloxetane, tetrahydrofurfuryl alcohol, solketal, glycerol formal, 1,4-dioxane-2,3-diol, and dihydrolevoglucosenone.

Among these, from the viewpoint of being able to further improve the abrasion resistance of recorded matter, 3-ethyl-3-oxetanemethanol (DMHD) is more preferable.

### 1.6.2 Polyols

Polyols have two or more hydroxy groups in the molecule. Examples of polyols include diols, triols, and higher polyols.

The number of carbon atoms in the molecule of polyols is preferably 15 or less, more preferably 10 or less, and even more preferably 6 or less. The lower limit of the number of carbon atoms is not particularly limited, and is preferably 2 or more, and more preferably 4 or more.

The normal boiling point of polyols is preferably 250° C. or lower, and more preferably 150 to 250° C.

### Diols

Diols have two hydroxy groups in the molecule. Examples of diols include alkanediols and condensates of two or more molecules of an alkanediol intermolecularly condensed between hydroxy groups (having two hydroxy groups in the molecule).

The glycol of alkanediols or the glycol unit of condensates of two or more molecules of an alkanediol intermolecularly condensed between hydroxy groups preferably has 2 to 10 carbon atoms, more preferably has 3 to 8 carbon atoms, and even more preferably has 4 to 6 carbon atoms.

Examples of alkanediols include ethylene glycol (normal boiling point: 198° C., miscible with water), 1,2-propanediol (propylene glycol: PG) (normal boiling point: 188° C., completely miscible with water), 1,2-butanediol (normal boiling point: 194° C., miscible with water), 1,2-pentanediol (normal boiling point: 210° C., miscible with water), 1,2-hexanediol (1,2HD, normal boiling point: 224° C., completely miscible with water), 1,3-propanediol (normal boiling point: 214° C., completely miscible with water), 1,4-butanediol (normal boiling point: 228° C., completely miscible with water), 2,3-butanediol (normal boiling point: 177° C., miscible with water), 1,3-butylene glycol (normal boiling point: 207° C., completely miscible with water), 3-methyl-1,3-butanediol (normal boiling point: 203° C., completely miscible with water), 2-methyl-1,3-propanediol (normal boiling point: 214° C., completely miscible with water), 2,2-dimethyl-1,3-propanediol (normal boiling point: 208° C., solubility: 83 [g/100 g of water]), 2-methylpentane-2,4-diol (normal boiling point: 197° C., completely miscible with water), 2,5-dimethyl-2,5-hexanediol (normal boiling point: 218° C., solubility: 14 [g/100 g of water]), 1,5-pentanediol (normal boiling point: 242° C., miscible with water), 3-methyl-1,5-pentanediol (normal boiling point: 250° C., completely miscible with water), and 1,6-hexanediol (normal boiling point: 250° C., miscible with water).

Among alkanediols, those having 2 or more carbon atoms are preferable. Further, alkanediols are preferably alkanediols having 2 to 10 carbon atoms, preferably 3 to 8 carbon atoms, and more preferably 4 to 6 carbon atoms.

In particular, alkanediols having 4 or more carbon atoms tend to be able to further improve the water solubility of the poorly water-soluble low-molecular-weight organic compound and to make clogging recoverability more excellent.

The ink jet ink composition according to the present embodiment preferably contains an alkanediol having 4 or more carbon atoms as the water-soluble low-molecular-weight organic compound in an amount of 1 to 5% by mass with respect to the total amount of the ink composition. In this case, there is a tendency that the water solubility of the poorly water-soluble low-molecular-weight organic compound can be further improved, and clogging recoverability is more excellent. The content of the alkanediol having 4 or more carbon atoms is more preferably 1 to 4% by mass, and even more preferably 1 to 3% by mass with respect to the total amount of the ink composition. In particular, it is more preferable that the content of an alkanediol having 4 to 6 carbon atoms be within the above range.

Examples of condensates of two or more molecules of an alkanediol intermolecularly condensed between hydroxy groups include dialkylene glycols such as diethylene glycol (normal boiling point: 244° C., completely miscible with water) and dipropylene glycol (normal boiling point: 227° C., completely miscible with water); and trialkylene glycols such as triethylene glycol (normal boiling point: 276° C., completely miscible with water) and tripropylene glycol (normal boiling point: 273° C., completely miscible with water).

When the ink contains an alkanediol having 3 or less carbon atoms or a condensate of two or more molecules of the alkanediol intermolecularly condensed between hydroxy groups, clogging recoverability and the like are more excellent, which is preferable. The total content of the alkanediol having 3 or less carbon atoms or the condensate of two or more molecules of the alkanediol intermolecularly condensed between hydroxy groups is preferably 1 to 30% by mass, more preferably 5 to 25% by mass, and even more preferably 10 to 20% by mass with respect to the total amount of the ink composition.

In particular, it is more preferable that the content of the alkanediol having 3 or less carbon atoms be within the above range.

### Triols and Higher Polyols

Triols and higher polyols have three or more hydroxy groups in the molecule. Examples thereof include compounds having three or more hydroxy groups and having an alkane or polyether structure as the skeleton. Examples of such compounds include glycerin (normal boiling point: 290° C., miscible with water); trimethylolethane (normal boiling point: 283° C., solubility: about 60 [g/100 g of water]), trimethylolpropane (normal boiling point: 295° C., completely miscible with water), and 1,2,6-hexanetriol (completely miscible with water).

Among the above polyols, alkanediols having a normal boiling point of 150 to 250° C. and having 10 or less carbon atoms are more preferable, and alkanediols having a normal boiling point of 150 to 250° C. and having 4 to 6 carbon atoms are even more preferable.

The ink jet ink composition according to the present embodiment preferably contains a water-soluble low-molecular-weight organic compound that is a polyol in an amount of 30% by mass or less, and more preferably 25% by mass or less with respect to the total amount of the ink composition. As the lower limit value thereof, the jet ink composition according to the present embodiment preferably contains the water-soluble low-molecular-weight organic compound that is a polyol in an amount of 5% by mass or more, more preferably 10% by mass or more, and even more preferably 15% by mass or more with respect to the total amount of the ink composition. Among polyols, polyols having a normal boiling point of 150 to 250° C. are preferable, alkanediols having a normal boiling point of 150 to 250° C. are more preferable, alkanediols having a normal boiling point of 150 to 250° C. and having 10 or less carbon atoms are even more preferable, alkanediols having a normal boiling point of 150 to 250° C. and having 4 to 6 carbon atoms are particularly preferable, and the content of these may be within the above range.

When these water-soluble low-molecular-weight organic compounds are contained within the above range, there is a tendency that clogging recoverability can be better.

The ink jet ink composition according to the present embodiment preferably does not contain a water-soluble low-molecular-weight organic compound that is a polyol having a normal boiling point of higher than 280° C. in an amount of greater than 3% by mass with respect to the total amount of the ink composition. Further, the ink jet ink composition more preferably does not contain the water-soluble low-molecular-weight organic compound that is a polyol having a normal boiling point of higher than 280° C. in an amount of greater than 1% by mass, and even more preferably does not contain it in an amount of greater than 0.5% by mass.

In this case, the ink may or may not contain the polyol having a normal boiling point of higher than 280° C., and even if the ink contains it, the content thereof is equal to or less than the above content. When the content of the polyol having a normal boiling point of higher than 280° C. is within the above range, the drying properties of the ink can be prevented from significantly decreasing, and as a result, even when recording is performed on the low- or non-absorbent recording medium is performed, there is a tendency that image fixability can be prevented from decreasing. In addition, there is a tendency that sufficient drying can be performed even when the temperature of the recording medium when heating and drying is performed is relatively low. Examples of such a polyol having a normal boiling point of higher than 280° C. include glycerin (normal boiling point: 290° C.).

### 1.6.3 Glycol Ethers

Glycol ethers are compounds with one or more hydroxy groups of glycols subjected to etherification. Glycol ethers are preferably monoethers or diethers of alkylene glycols. The ether for the etherification is preferably an alkyl ether. The alkylene of the alkylene glycol and the alkyl of the alkyl ether constituting glycol ethers independently preferably have 1 to 5 carbon atoms, and more preferably have 2 to 4 carbon atoms. Glycol ethers having a normal boiling point of 150 to 250° C. are preferable.

Examples of glycol ethers include alkylene glycol monoalkylethers such as ethylene glycol monomethyl ether (completely miscible with water), ethylene glycol monoethyl ether (miscible with water), ethylene glycol monoisopropyl ether (solubility: 100 [g/100 g of water]), ethylene glycol monopropyl ether (miscible with water), ethylene glycol monoisobutyl ether (solubility: 75.5 [g/100 g of water]), ethylene glycol mono-tert-butyl ether (miscible with water), ethylene glycol monobutyl ether (solubility: 100 [g/100 g of water]), diethylene glycol monomethyl ether (completely miscible with water), diethylene glycol monoethyl ether (completely miscible with water), diethylene glycol monoisopropyl ether (miscible with water), diethylene glycol monoisobutyl ether (completely miscible with water), diethylene glycol monobutyl ether (completely miscible with water), triethylene glycol monomethyl ether (completely miscible with water), triethylene glycol monoethyl ether (completely miscible with water), triethylene glycol monobutyl ether (miscible with water), tetraethylene glycol monomethyl ether (miscible with water), propylene glycol monomethyl ether (miscible with water), propylene glycol monoethyl ether (completely miscible with water), propylene glycol monopropyl ether (miscible with water), dipropylene glycol monomethyl ether (completely miscible with water), dipropylene glycol monopropyl ether (solubility: 19 [g/100 g of water]), tripropylene glycol monomethyl ether (completely miscible with water), 1,3-propanediol monomethyl ether (3-methoxy-1-propanol) (completely miscible with water), and 1,3-butylene glycol-3-monomethyl ether (3-methoxy-1-butanol) (miscible with water).

Examples of glycol ethers include alkylene glycol dialkylethers (glymes) such as ethylene glycol dimethyl ether (completely miscible with water), diethylene glycol dimethyl ether (completely miscible with water), diethylene glycol methyl ethyl ether (completely miscible with water), diethylene glycol diethyl ether (completely miscible with water), triethylene glycol dimethyl ether (completely miscible with water), tetraethylene glycol dimethyl ether (completely miscible with water), dipropylene glycol dimethyl ether (solubility: 52.6 [g/100 g of water]), and tripropylene glycol dimethyl ether (solubility: 23.6 [g/100 g of water]).

Among the glycol ethers, diethers tend to be more likely to dissolve or swell the resin in the ink than monoethers, and are preferable in that the abrasion resistance of images to be formed is improved. On the other hand, monoethers are preferable in that they are excellent in the wettability and spreadability of the ink.

### 1.6.4 Alkanolamines

Alkanolamines are compounds having a hydroxy group and an amino group in an alkane skeleton. Alkanolamines have one or more hydroxy groups, preferably have one to five hydroxy groups, and more preferably have two or three hydroxy groups in the molecule. Alkanolamines preferably have 1 to 20 carbon atoms, more preferably have 2 to 10 carbon atoms, and even more preferably have 6 to 9 carbon atoms in the molecule. The alkane skeleton preferably has 1 to 6 carbon atoms, and more preferably has 2 to 4 carbon atoms per alkane skeleton. Alkanolamines have one or more amino groups, preferably have one to five amino groups, and more preferably have one or two amino groups in the molecule.

Alkanolamines are not particularly limited, and examples thereof include ethanolamine (miscible with water), N-methylethanolamine (solubility: 100 [g/100 g of water]), N,N-dimethylethanolamine (completely miscible with water), N-ethylethanolamine (miscible with water), N-butylethanolamine (miscible with water), N,N-diethylethanolamine (miscible with water), diethanolamine (solubility: 100 [g/100 g of water]), N-methyldiethanolamine (solubility: 100 [g/100 g of water]), N-ethyldiethanolamine (miscible with water), N-butyldiethanolamine (miscible with water), N-tert-butyldiethanolamine (completely miscible with water), triethanolamine (TEA, completely miscible with water), isopropanolamine (miscible with water), N,N-dimethylisopropanolamine (completely miscible with water), N,N-diethylisopropanolamine (miscible with water), diisopropanolamine (solubility: 87 [g/100 g of water]), triisopropanolamine (TIPA, normal boiling point: 301° C., solubility: 83 [g/100 g of water]), N,N-dimethylpropanolamine (miscible with water), 2-amino-1-propanol (completely miscible with water), 2-amino-2-methyl-1-propanol (completely miscible with water), 5-amino-1-pentanol (miscible with water), 2-amino-2-methyl-1,3-propanediol (miscible with water), 2-amino-2-hydroxymethyl-1,3-propanediol (miscible with water), 3-amino-1,2-propanediol (miscible with water), 3-methylamino-1,2-propanediol (completely miscible with water), tripropanolamine, and tributanolamine.

Among these, triethanolamine (TEA) and triisopropanolamine (TIPA) are preferable, and triisopropanolamine (TIPA) is more preferable.

The normal boiling point of alkanolamines is preferably 280° C. or higher, more preferably 290° C. or higher, and even more preferably 300° C. or higher. The upper limit of the normal boiling point of alkanolamines is not particularly limited, and is preferably 350° C. or lower, more preferably 330° C. or lower, and even more preferably 310° C. or lower.

The ink jet ink composition according to the present embodiment preferably contains an alkanolamine having a normal boiling point of 280° C. or higher in an amount of 0.2% by mass or more with respect to the total amount of the ink composition. In this case, the alkanolamine acts as a pH buffer to stabilize the pH, and there is a tendency that the dispersion stability of the pigment and the like becomes better, and clogging recoverability is more excellent. In addition, the pH of the ink is easily adjusted to 8 or more, which is preferable. The lower limit thereof may be 0.05% by mass or more, may be 0.1% by mass or more, and is more preferably 0.3% by mass or more. The upper limit thereof is preferably 5% by mass or less, more preferably 3% by mass or less, even more preferably 1.5% by mass or less, particularly preferably 1.0% by mass or less, and more particularly preferably 0.7% by mass or less.

### 1.7 Defoaming Agent

The ink jet ink composition according to the present embodiment may contain a defoaming agent. When the defoaming agent is contained, there is a tendency that bubbles generated in the ink composition are eliminated, and more excellent ejection stability is obtained. Note that the surfactant and the defoaming agent are different components.

The defoaming agent is not particularly limited, and examples thereof include silicone-based defoaming agents, polyether-based defoaming agents, fatty acid ester-based defoaming agents, and acetylene glycol-based defoaming agents. Examples of commercially available products of the defoaming agent include BYK-011, BYK-012, BYK-017, BYK-018, BYK-019, BYK-020, BYK-021, BYK-022, BYK-023, BYK-024, BYK-025, BYK-028, BYK-038, BYK-044, BYK-080A, BYK-094, BYK-1610, BYK-1615, BYK-1650, BYK-1730, and BYK 1770 (product names, manufactured by BYK Japan K.K.) and Surfynol DF37, DF110D, DF58, DF75, DF220, and MD-20, and Envirogem AD01 (all of which are product names, manufactured by Nissin Chemical Co., Ltd.). One of the defoaming agents may be used alone, or a mixture of two or more thereof may be used.

The content of the defoaming agent is preferably 0.01 to 1% by mass, more preferably 0.03 to 0.5% by mass, even more preferably 0.05 to 0.3% by mass, and particularly preferably 0.07 to 0.15% by mass with respect to the total amount of the ink composition.

### 1.8 Alkali Compound

The ink jet ink composition according to the present embodiment may contain an alkali compound. Examples of the alkali compound include inorganic alkali compounds such as hydroxides of alkali metals or alkaline earth metals; and organic alkali compounds such as amine compounds.

Examples of inorganic alkali compounds include hydroxides of alkali metals or alkaline earth metals, such as lithium hydroxide, sodium hydroxide, potassium hydroxide, and calcium hydroxide.

When the ink contains or does not contain an inorganic alkali compound, the content of the inorganic alkali compound is preferably 0.06% by mass or less with respect to the total amount of the ink composition. That is, the ink preferably does not contain the inorganic alkali compound in an amount of greater than 0.06% by mass. Further, the content is more preferably 0.04% by mass or less, even more preferably 0.02% by mass or less, and particularly preferably 0.01% by mass or less, and the ink may contain no inorganic alkali compound. When the content is within or less than the above range, the pH of the ink is easily set to the above range, and clogging recoverability and abrasion resistance are more excellent, which is preferable.

Examples of the amine compound include primary amines, secondary amines, and tertiary amines. Note that ammonia is also included in the amine compound. The molecular weight of the amine compound is not particularly limited, and is preferably 500 or less, more preferably 300 or less, even more preferably 250 or less, and particularly preferably 200 or less. The lower limit of the molecular weight is not particularly limited, and is preferably 40 or more, more preferably 80 or more, and even more preferably 120 or more.

Examples of the primary amine include methylamine, ethylamine, n-propylamine, isopropylamine, n-butylamine, isobutylamine, sec-butylamine, and tert-butylamine.

Examples of the secondary amine include N,N-dimethylamine, N,N-diethylamine, N,N-di-n-propylamine, N,N-diisopropylamine, N,N-di-n-butylamine, N,N-diisobutylamine, and N,N-di-sec-butylamine.

Examples of the tertiary amine include trimethylamine, triethylamine, tri-n-propylamine, tri-n-butylamine, triethanolamine, triisopropanolamine, and trishydroxymethylaminomethane.

Note that the water-soluble low-molecular-weight organic compound such as alkanolamines and the poorly water-soluble low-molecular-weight organic compound described above, which exhibit alkalinity when made into an aqueous solution, may be a kind of the organic alkali compound.

The alkali compound is preferably the amine compound, and more preferably alkanolamines in particular. Alkanolamines also act as a pH buffer to stabilize the pH of the ink, and there is tendency that the dispersion stability of the pigment and the like can be better. In addition, clogging recoverability, abrasion resistance, and the like are more excellent, which is preferable.

### 1.9 Other Components

The ink jet ink composition according to the present embodiment may contain various additives such as waxes, chelating agents, rust inhibitors, antifungal agents, antioxidants, reduction inhibitors, and evaporation accelerators, if necessary.

### 1.10 Physical Properties

The ink jet ink composition according to the present embodiment has a pH of 8 to 10.

The pigment and the resin particles for use in the ink jet ink composition are preferably dispersed in water by an alkali-soluble polymer dispersant or a surfactant.

When the pH of the ink is closer to alkalinity, the terminal group of the dispersant is in a chemical equilibrium in an ionized state, and thus electric repulsive force becomes strong, and flocculation is less likely to occur. In view of this, a way of improving clogging recoverability by more increasing the pH of the ink is considered, but in the water-based ink containing the poorly water-soluble low-molecular-weight organic compound, the solubility of the poorly water-soluble low-molecular-weight organic compound decreases, and it easily forms foreign matter, and thus clogging recoverability rather deteriorates. Thus, the pH of the ink is set to 10 or less. In addition, the silicone-based surfactant tends to be hydrolyzed at a high pH, and the silicone-based surfactant is decomposed due to long-term storage, and sufficient wettability and spreadability of the ink cannot be obtained, and thus the pH of the ink is set to 10 or less also in this point. When the pH of the ink is 10 or less, the hydrolysis of the silicone-based surfactant can be inhibited.

On the other hand, when the pH of the ink is closer to neutrality, the re-adsorption of counter ions to the terminal group occurs, and thus the electric repulsive force is weakened, and the flocculation of the resin or the pigment is likely to occur. Thus, the pH of the ink is set to 8 or more.

The ink jet ink composition according to the present embodiment has a pH of 8 or more, which is preferably 8.1 or more, more preferably 8.2 or more, even more preferably 8.3 or more, and particularly preferably 8.4 or more. In addition, the ink jet ink composition according to the present embodiment has a pH of 10 or less, which is preferably 9.5 or less, more preferably 9.0 or less, even more preferably 8.8 or less, and particularly preferably 8.5 or less. When the pH is within the above range, clogging recoverability tends to be more excellent.

### 1.11 Uses

The ink jet ink composition according to the present embodiment is used for recording on a recording medium that is a low-absorbent recording medium or a non-absorbent recording medium.

“Low-absorbent recording medium or non-absorbent recording medium” refers to a recording medium having a property of not absorbing liquid at all or hardly absorbing liquid. Quantitatively, “low-absorbent recording medium or non-absorbent recording medium” refers to a “recording medium having a water absorption amount of 10 mL/m² or less from the start of contact to 30 msec^{1/2} in the Bristow method.” The Bristow method is the most popular method for measuring the amount of liquid absorption in a short time, and is also adopted by Japan Technical Association of the Pulp and Paper Industry (JAPAN TAPPI). The details of the test method are described in the standard No. 51 “Paper and paperboard-Liquid absorbency test method-Bristow method” of “JAPAN TAPPI Paper Pulp Test Method 2000 Edition.”

The low-absorbent recording medium is not particularly limited, and examples thereof include coated paper provided with a coating layer for receiving ink on the surface thereof. The coated paper is not particularly limited, and examples thereof include printing paper such as art paper, coated paper, and matte paper. The coating layer is a layer that is less likely to absorb ink, and examples thereof include a layer coated with particles of an inorganic compound or the like together with a binder.

The non-absorbent recording medium is not particularly limited, and examples thereof include recording media such as plastic, glass, metal, and ceramic.

When the recording medium is plastic, it is, for example, a plastic film. Examples of the plastic film include polyester films, polyurethane films, polycarbonate films, polyphenylene sulfide films, polyimide films, and polyamide-imide films. Other examples thereof include polyolefins such as polyethylene and polypropylene, and polyvinyl chloride. Other examples thereof include biomass-derived plastic films such as PLA, PBS, PHA, bio-PE, bio-PP, and bio-PET.

In addition, films made of plastic, base materials such as paper coated with plastic, and base materials such as paper to which a plastic film is bonded may be used.

When the recording medium is a metal, base materials made of metals such as iron, silver, copper, and aluminum or base materials other than metals, such as plastic, having recording surfaces on which such various metals are deposited may be used. In other words, it is sufficient that the recording surface be made of a metal.

The recording medium may be a recording medium having translucency, such as a colorless transparent medium, a semi-transparent medium, or a colored transparent medium. Alternatively, it may be a recording medium not having translucency, such as a chromatic opaque medium or an achromatic opaque medium. In addition, as the recording medium, objects having a three-dimensional shape such as a sheet shape, a spherical shape, or a rectangular parallelepiped shape, paper containers, and the like may be used.

Among these recording media, from the viewpoint that the effects produced by the present disclosure can be further enjoyed, the non-absorbent recording medium is preferable, and, in particular, a recording medium having a printing surface made of polyvinyl chloride is more preferable. That is, since an ink is less likely to wet and spread on such a recording medium, a problem of image quality is particularly likely to occur. However, with the ink jet ink composition according to the present embodiment, even for such a recording medium, there is a tendency that it is possible to obtain excellent image quality and excellent clogging recoverability of an ink jet head.

### 2. RECORDING METHOD

A recording method according to an embodiment of the present disclosure includes a step of ejecting the ink jet ink composition described above from an ink jet head to cause the ink jet ink composition to adhere to a recording medium that is a low-absorbent recording medium or a non-absorbent recording medium.

In the recording method according to the present embodiment, by using the ink jet ink composition described above, it is possible to obtain excellent image quality and to excellent clogging recoverability of an ink jet head.

Each step in the recording method according to the present embodiment will be described below.

### 2.1 Ink Adhesion Step

The recording method according to the present embodiment includes a step (an ink adhesion step) of ejecting the ink jet ink composition described above from an ink jet head to cause the ink jet ink composition to adhere to a recording medium that is a low-absorbent recording medium or a non-absorbent recording medium.

The low-absorbent recording medium or the non-absorbent recording medium is as described above, and the description thereof will be omitted.

In the ink adhesion step, the adhesion amount of the ink composition per unit area of the recording medium in an ink adhesion area of the recording medium is preferably 15 mg/inch² or less, more preferably 13 mg/inch² or less, and even more preferably 12 mg/inch² or less.

Even when the adhesion amount of the ink composition is within the above range, the filling of the ink on the recording medium is good, and excellent image quality tends to be obtained. In addition, the adhesion amount of the ink composition per unit area of the recording medium in an area in which the adhesion amount of the ink is the maximum in the ink adhesion area of the recording medium, that is, the maximum adhesion amount of the ink may be set to be within the above range, which is preferable.

In the ink adhesion step, the surface temperature of the recording medium when the ink jet ink composition described above is caused to adhere to the recording medium is preferably 55° C. or lower. In this case, the ink adhesion step may be performed without heating the recording medium, or may be performed while heating the recording medium. That is, when heating is performed, the heating is preferably performed such that the surface temperature of the recording medium becomes 55° C. or lower.

The upper limit value of the surface temperature of the recording medium at the time of the ink adhesion is preferably 55° C. or lower, more preferably 50° C. or lower, even more preferably 45° C. or lower, particularly preferably 40° C. or lower, more particularly preferably 35° C. or lower, and even more particularly preferably 28° C. or lower. On the other hand, the lower limit value thereof is preferably 20° C. or higher, more preferably 23° C. or higher, and particularly preferably 25° C. or higher. Further, the temperature is preferably 28° C. or higher, more preferably 35° C. or higher, and even more preferably 40° C. or higher.

### 2.2 Primary Drying Step

The recording method according to the present embodiment may include a primary drying step of drying the ink jet ink composition that has adhered to the recording medium.

In a recording method, a primary drying step is preferable in that the ink can be rapidly dried on the recording medium, and image quality can be good. On the other hand, since the ink is rapidly dried in the primary drying step, the ink is less likely to wet and spread on the recording medium. That is, the recording method including the primary drying step is likely to cause a problem of image quality. However, in the recording method according to the present embodiment, even in such a case, there is a tendency that it is possible to obtain excellent image quality and excellent clogging recoverability of an ink jet head.

The primary drying step is a step of drying the ink that has adhered to the recording medium at an early stage. The primary drying step is a step of drying at least part of the solvent component of the ink to such an extent that at least the fluidity of the ink that has adhered to the recording medium is reduced. In the primary drying step, it is preferable that ink droplets that have landed on the recording medium be started to be dried within 0.5 second at the latest from the landing of the ink droplets.

Examples of the unit of the primary drying step include an air blowing type that is a method based on air blowing at normal temperature (normal temperature air) or air blowing with heating (warm air) to the recording medium by a fan or the like, an IR heater, a microwave radiation type, a heat transfer type based on heating of the recording medium by a platen heater or the like, and a method combining these. Here, the primary drying step in the present embodiment is not particularly limited so long as the drying properties of the ink can be improved, and heating is not necessarily required to be involved. Thus, in the primary drying step of the present embodiment, the method based on air blowing at normal temperature may be used alone. Note that the primary drying step is more preferably a method involving heating.

When the drying by air blowing is performed in the primary drying step, the wind velocity of the air blowing is preferably 0.5 to 15 m/s, more preferably 0.5 to 10 m/s, even more preferably 1 to 5 m/s, and particularly preferably 2 to 3 m/s. The wind velocity is a wind velocity near the surface of the recording medium.

The temperature of the air blowing is preferably 55° C. or lower, and preferably 10° C. or higher. Further, the temperature is preferably 15 to 50° C., and more preferably 20 to 49° C. Further, the temperature is preferably 23 to 40° C., more preferably 25 to 35° C., and even more preferably 25 to 28° C. The wind temperature of the air blowing may be room temperature.

The surface temperature of the recording medium in the primary drying step may be in the range of the temperature described as the surface temperature of the recording medium in the ink adhesion step described above, and is preferable. That is, the surface temperature of the recording medium in the primary drying step is preferably 55° C. or lower in particular, and more preferably in the surface temperature range described above.

When the drying temperature in the primary drying step is within the above range, drying of the ink in the ink jet head can be reduced, and thus clogging recoverability tends to be more excellent.

Note that when heating is performed in the primary drying step, in the primary drying step, the ink may be caused to adhere to the heated recording medium, or the ink may be heated at an early stage after the adhesion. In the primary drying step, it is preferable that ink droplets that have landed on the recording medium be started to be heated within 0.5 second at the latest from the landing of the ink droplets.

When heating is involved in the primary drying step, the heating may be performed at least any of before the ink adhesion step described above, at the same time as the adhesion, and at an early stage after the adhesion, and is preferably performed at the same time. In such a heating order, the primary drying step can be performed.

Note that the surface temperature of the recording medium in the primary drying step is the surface temperature of the recording medium at the time of the ink adhesion when the ink is caused to adhere to the recording medium subjected to the primary drying step, and is the surface temperature of the recording medium at the time of performing the primary drying step when the primary drying step is performed at an early stage after the ink adhesion. The temperature is the maximum temperature by the primary drying step in the primary drying step. The surface temperature of the recording medium in the primary drying step at those times is preferably within the range of the surface temperature of the recording medium at the time of the ink adhesion described above.

The surface temperature of the recording medium when heating is not involved in the primary drying step is the surface temperature of the recording medium at the time of the ink adhesion.

### 2.3 Later Heating Step

The recording method according to the present embodiment may include a later heating step of heating the recording medium after the ink adhesion step described above. Since the ink jet ink composition for use in the recording method according to the present embodiment contains the poorly water-soluble low-molecular-weight organic compound, the drying properties after the ink adhesion step are better than a case in which the poorly water-soluble low-molecular-weight organic compound is not contained. When the recording method according to the present embodiment includes the later heating step, the drying properties can be further improved, and thus there is a tendency that recorded matter having more excellent abrasion resistance can be obtained, which is preferable.

The later heating step is a heating step of sufficiently heating the recording medium so that the recording is completed and the recorded matter can be used. The later heating step is a heating step of sufficiently drying the solvent component of the ink and heating the resin particles and the like contained in the ink to flatten a coating film of the ink. The later heating step is preferably started greater than 0.5 second after the adhesion of the ink to the recording medium. For example, it is preferable that greater than 0.5 second after the adhesion of the ink to a certain recording area of the recording medium is all completed, heating of the area be started. The temperature preferable in the primary drying step and the temperature preferable in the later heating step are preferably different from each other.

The heating of the recording medium in the later heating step can be performed using an appropriate heating unit, for example, when an ink jet recording apparatus is used. The heating is not limited to the heating unit provided in the ink jet recording apparatus, and can be performed by an appropriate heating unit. The surface temperature of the recording medium in this case is preferably 60° C. or higher, more preferably 70° C. or higher, even more preferably 80° C. or higher, and particularly preferably 85° C. or higher. The surface temperature of the recording medium heated in the later heating step is preferably 120° C. or lower, more preferably 110° C. or lower, even more preferably 100° C. or lower, and particularly preferably 95° C. or lower. In the recording method according to the present embodiment, even when the surface temperature of the recording medium is within the above range, there is a tendency that the ink is sufficiently dried, and recorded matter having excellent abrasion resistance is obtained.

### 2.4 Ink Jet Recording Apparatus

An example of an ink jet recording apparatus that can be suitably used in the recording method according to the present embodiment will be described with reference to the drawings.

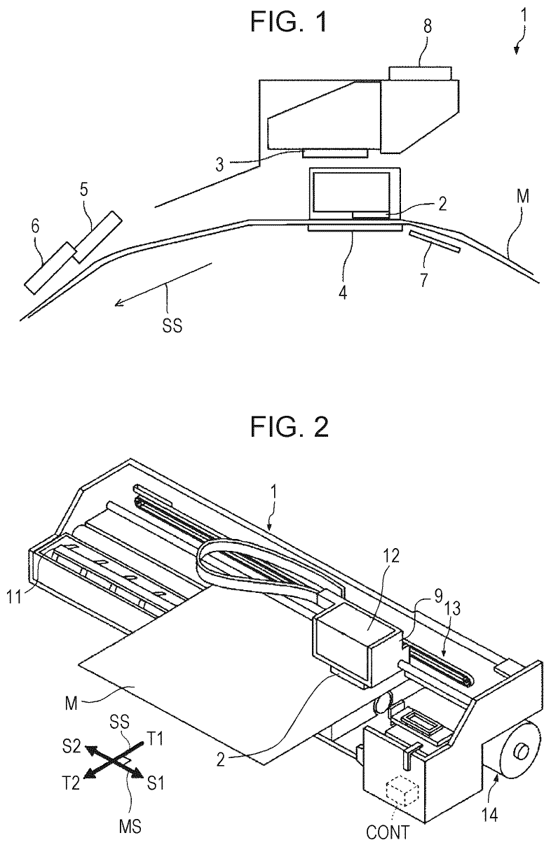

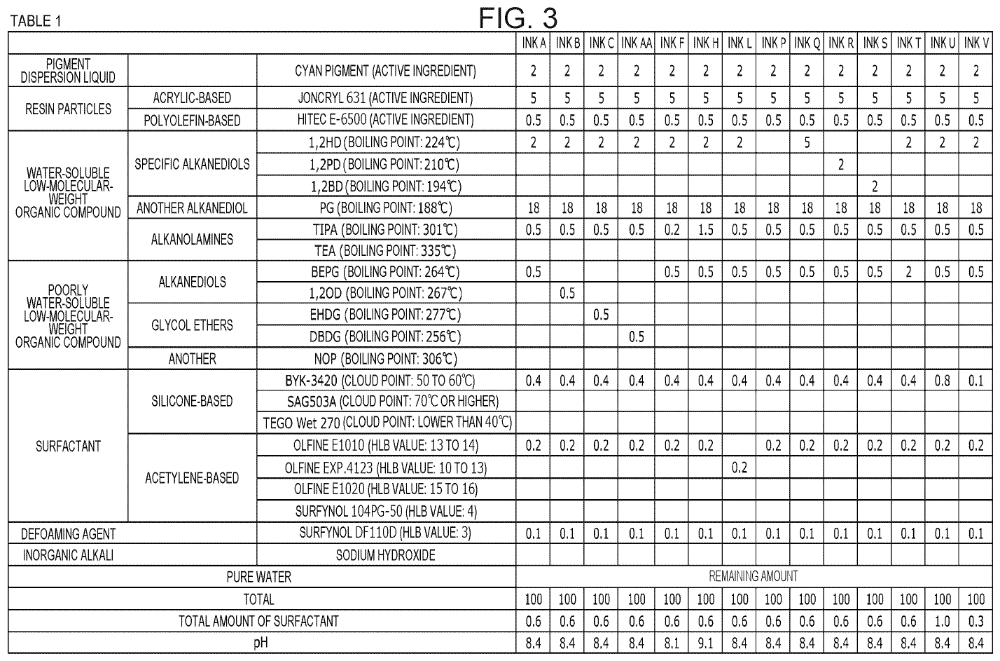

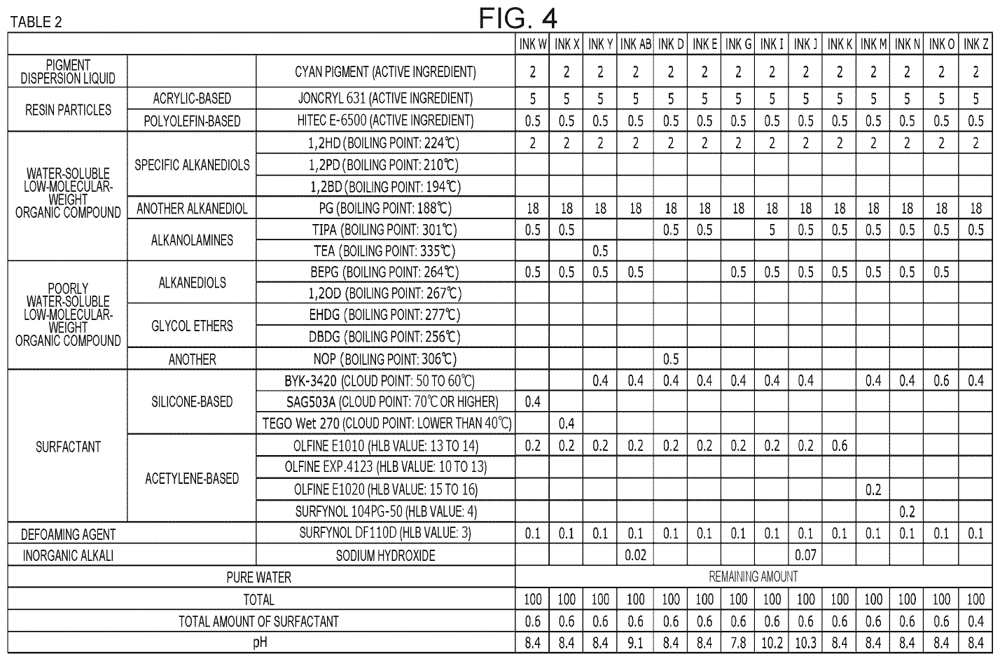

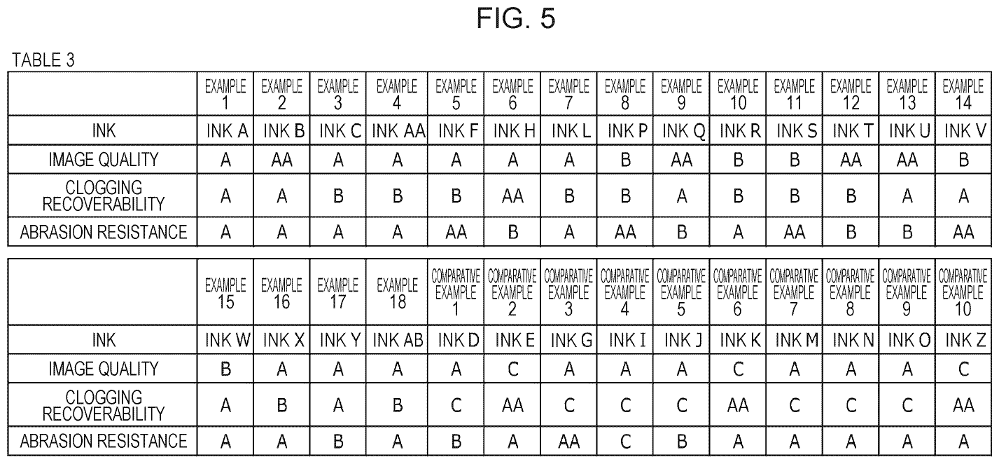

FIG. 1 is a schematic sectional view schematically showing an ink jet recording apparatus. FIG. 2 is a perspective view of an example of a configuration around a carriage of the ink jet recording apparatus 1 in FIG. 1. As shown in FIGS. 1 and 2, the ink jet recording apparatus 1 includes an ink jet head 2, an IR heater 3, a platen heater 4, a heater 5, a cooling fan 6, a preheater 7, a ventilation fan 8, a carriage 9, a platen 11, a carriage moving mechanism 13, a transport unit 14, and a control section CONT. In the ink jet recording apparatus 1, the operation of the entire ink jet recording apparatus 1 is controlled by the control section CONT shown in FIG. 2.

The ink jet head 2 is configured to perform recording on a recording medium M by ejecting an ink jet ink composition from a nozzle of the ink jet head 2 to cause the ink jet ink composition to adhere to the recording medium M. The ink jet head 2 shown in FIG. 1 and FIG. 2 is a serial type ink jet head, and causes the ink to adhere to the recording medium M by scanning a plurality of times in a main scanning direction relative to the recording medium M. The ink jet head 2 is mounted on the carriage 9 shown in FIG. 2. The ink jet head 2 is scanned a plurality of times in the main scanning direction relative to the recording medium M by the operation of the carriage moving mechanism 13 that moves the carriage 9 in the medium width direction of the recording medium M. The medium width direction is the main scanning direction of the ink jet head 2. Scanning in the main scanning direction is also referred to as main scanning.

Here, the main scanning direction is a direction in which the carriage 9 on which the ink jet head 2 is mounted moves. In FIG. 1, the main scanning direction is a direction crossing a sub-scanning direction, which is a transport direction of the recording medium M indicated by the arrow SS. In FIG. 2, the width direction of the recording medium M, that is, the direction represented by S1-S2 is a main scanning direction MS, and the direction represented by T1→T2 is a sub-scanning direction SS. Note that scanning is performed in the main scanning direction, that is, in either one direction of the arrow S1 or the arrow S2 in one scan. Recording is performed on the recording medium M by repeatedly performing the main scanning of the ink jet head 2 and sub-scanning, which is the transport of the recording medium M, a plurality of times.

The cartridge 12 that supplies the ink to the ink jet head 2 includes a plurality of independent cartridges. The cartridge 12 is detachably mounted on the carriage 9 on which the ink jet head 2 is mounted. Each of the cartridges can be filled with a different type of ink jet ink composition, and the ink jet ink composition is supplied from the cartridge 12 to each nozzle. Note that FIG. 1 and FIG. 2 show an example in which the cartridge 12 is mounted on the carriage 9, but this is not limiting, and it may be provided at a location other than the carriage 9, and the ink jet ink composition may be supplied to each nozzle through a supply pipe, not shown. A known system can be used for the ejection by the ink jet head 2. Here, a system of ejecting droplets by using the vibration of a piezoelectric element, that is, an ejection system of forming ink droplets by the mechanical deformation of an electrostrictive element is used.

The ink jet recording apparatus 1 can include a primary drying mechanism that dries the recording medium M when the ink is ejected from the ink jet head 2 and is caused to adhere to the recording medium. As the primary drying mechanism, a conduction type, an air blowing type, a radiation type, or the like can be used. The conduction type conducts heat from a member in contact with the recording medium to the recording medium. Examples thereof include a platen heater. The air blowing type sends normal temperature air or warm air to the recording medium to dry the ink. Examples thereof include an air blowing fan. The radiation type radiates heat-generating radiation to the recording medium to heat the recording medium. Examples thereof include IR radiation. Further, although not shown, a heater similar to the platen heater 4 may be provided immediately downstream of the platen heater in the SS direction. These primary drying mechanisms may be used alone or in combination. For example, the IR heater 3 and the platen heater 4 are included as the primary drying mechanism.

Note that when the IR heater 3 is used, the recording medium M can be heated on the radiation type by the radiation of infrared rays from the side closer to the ink jet head 2. With this, the ink jet head 2 is also likely to be heated at the same time, but the temperature can be increased without being affected by the thickness of the recording medium M, compared to a case in which heating is performed from the back of the recording medium M as in the platen heater 4 or the like. Note that various fans (for example, the ventilation fan 8) may be provided for drying the ink on the recording medium M by blowing warm air or air having the same temperature as the environment against the recording medium M.

The platen heater 4 can heat the recording medium M via the platen 11 at a position facing the ink jet head 2. The platen heater 4 can heat the recording medium M on the conduction type, and is used as needed in the ink jet recording method.

In addition, the ink jet recording apparatus 1 may include the preheater 7 that heats the recording medium M in advance before the ink is caused to adhere to the recording medium M.

A later heating mechanism that heats the recording medium to dry and fix the ink may be provided after the ink adhesion step.

The heater 5 used in the later heating mechanism dries and solidifies the ink that has adhered to the recording medium M. When the heater 5 heats the recording medium M on which an image is recorded, water and the like contained in the ink are more rapidly evaporated and scattered, and an ink film is formed by the resin particles contained in the ink. In this way, the ink film is firmly fixed or bonded to the recording medium M, film forming properties become excellent, and an excellent high-quality image can be obtained in a short time.

The ink jet recording apparatus 1 may include the cooling fan 6. After the ink recorded on the recording medium M is dried, by cooling the ink on the recording medium M by the cooling fan 6, an ink coating film can be formed on the recording medium M with good adhesion.

Included below the carriage 9 are the platen 11 that supports the recording medium M, the carriage moving mechanism 13 that moves the carriage 9 relative to the recording medium M, and the transport unit 14 that is a roller that transports the recording medium M in the sub-scanning direction. The operations of the carriage moving mechanism 13 and the transport unit 14 are controlled by the control section CONT.

### 3. EXAMPLES

The present disclosure will be described below more specifically with reference to examples, but the present disclosure is not limited to these examples. Hereinafter, “%” is based on mass unless otherwise specified.

### 3.1 Preparation of Ink Jet Ink Composition

Each component was put in a container so as to have the composition shown in Table 1 and Table 2, the components were mixed and stirred with a magnetic stirrer for 2 hours, and then the mixture was filtered with a membrane filter having a pore size of 5 μm to obtain an ink jet ink composition according to each Example and each Comparative Example. Note that the numerical values of the pigment and the resin particles in the tables represent the solid content thereof. Note that the pure water was added such that the total mass of the composition was 100% by mass. As the pigment, a pigment dispersion liquid prepared in advance by the following procedure was used.

### Preparation of Pigment Dispersion Liquid

First, 50 g of methyl ethyl ketone (MEK) was added to a flask equipped with a dropping funnel, a nitrogen inlet tube, a reflux cooling tube, a thermometer, and a stirrer, and was heated to 75° C. while bubbling with nitrogen. A mixture of monomers of 80 g of butyl methacrylate, 50 g of methyl methacrylate, 15 g of styrene, and 20 g of methacrylic acid, 50 g of MEK, and 500 mg of a polymerization initiator (azobisisobutyronitrile/AIBN) was added dropwise thereto from the dropping funnel over 3 hours. After the dropwise addition, the mixture was further heated under reflux for 6 hours, and was allowed to cool, and MEK in an amount corresponding to the volatilized one was added thereto to obtain a polymer solution (polymer solid content: 50% by mass, acid value: 79 mg/KOH, Tg: 65° C.). To 20 g of the solution, a predetermined amount of a 20% by mass aqueous sodium hydroxide solution was added as a neutralizing agent to neutralize 100% of salt-forming groups, 50 g of a pigment (C.I. Pigments Blue 15:3) was added thereto in small portions with stirring, and the mixture was kneaded with a bead mill for 2 hours. Ion exchanged water in an amount of 200 g was added to the obtained kneaded product, which was stirred, and then MEK was distilled off by heating under reduced pressure. Further, the concentration was adjusted with pure water to obtain a pigment dispersion (pigment solid content: 20% by mass, resin solid content: 5% by mass).

The components shown in Table 1 and Table 2 will be supplementarily described.
Joncryl 631: a product name, manufactured by BASF
Hitec E-6500: a product name, manufactured by Toho Chemical Industry Co., Ltd., a polyethylene wax emulsion
1,2HD: 1,2-hexanediol, miscible with water
1,2PD: 1,2-pentanediol, miscible with water
1,2BD: 1,2-butanediol, miscible with water
PG: propylene glycol, miscible with water
TIPA: triisopropanolamine, miscible with water
TEA: triethanolamine, miscible with water
BEPG: 2-butyl-2-ethyl-1,3-propanediol (butylethyl propanediol), normal boiling point: 264° C., melting point: 41° C., solubility 0.9 [g/100 g of water]
1,2OD: 1,2-octanediol, normal boiling point: 267° C., melting point: 28° C., solubility: 0.3 [g/100 g of water]
EHDG: diethylene glycol mono-2-ethylhexyl ether (2-ethylhexyl diglycol), normal boiling point: 277° C., melting point: −82° C., solubility: 0.5 [g/100 g of water]
DBDG: diethylene glycol dibutyl ether, normal boiling point: 256° C., melting point: −60° C., solubility: 0.3 [g/100 g of water]
NOP: n-(n-octyl)-2-pyrrolidone, normal boiling point: 306° C., melting point: −23° C., liquid (25° C.), a cyclic amide, solubility: 0.1 [g/100 g of water]
BYK-3420: a product name, manufactured by BYK Japan K.K.
SAG503A: a product name, manufactured by Nissin Chemical Co., Ltd.
TEGO Wet 270: a product name, manufactured by Evonik Industries
Olfine E1010: a product name, manufactured by Nissin Chemical Co., Ltd.
Olfine EXP.4123: a product name, manufactured by Nissin Chemical Co., Ltd.
Olfine E1020: a product name, manufactured by Nissin Chemical Co., Ltd.
Surfynol 104PG-50: a product name, manufactured by Nissin Chemical Co., Ltd.
Surfynol DF110D: a product name, manufactured by Nissin Chemical Co., Ltd.

### 3.2 Printing Conditions

The following printing conditions were used for printing in the evaluation tests described below.
Printing machine: “SC-R5050,” manufactured by Seiko Epson Corporation
Resolution: 1,200×1,200 dpi
Number of scans: nine times
Platen heating temperature: 45° C.
Secondary drying temperature: 80° C.
Recording medium: “Orajet 3165G-010,” manufactured by Orafol Japan Inc., a vinyl chloride film
Platen gap: 1.7 mm

The “platen heating temperature” is the surface temperature of the recording medium in a platen area facing the ink jet head during recording. The “secondary drying temperature” is the surface temperature of the recording medium heated by a secondary heater provided downstream of the ink jet head. The heating and drying at the secondary drying temperature were performed for about 3 minutes.

### 3.3 Evaluation Tests

### 3.3.1 Image Quality

The ink jet ink composition obtained above was charged into the SC-R5050, and a solid pattern was printed on the recording media based on the printing conditions. At this time, the ink adhesion amount was set in 1 mg/inch² increments from 10 to 14 mg/inch². The printed matter was visually observed and evaluated according to the following evaluation criteria. A case in which the surface of the recording medium was filled with the ink and the ground of the recording medium was not visible was evaluated to be good filling.

### Evaluation Criteria

AA: good filling with an ink adhesion amount of 12 mg/inch²
A: good filling with an ink adhesion amount of 13 mg/inch²
B: good filling with an ink adhesion amount of 14 mg/inch²
C: not filled even with an ink adhesion amount of 14 mg/inch²

### 3.3.2 Clogging Recoverability

The ink jet ink composition obtained above was charged into the SC-R5050, and then the nozzle surface was tapped with a Bemcot moistened with water to intentionally cause nozzle non-ejection. In this state, idling was performed for 2 hours in a 40° C., 15% environment. After recording based on the printing conditions, cleaning was performed three times, and the number of unrecovered nozzles was counted. In one cleaning, the ink in an amount of 1 g was discharged from a nozzle group. Note that the nozzle group includes 800 nozzles.

### Evaluation Criteria

AA: a nozzle non-ejection of less than 1%
A: a nozzle non-ejection of 1% or more and less than 2%
B: a nozzle non-ejection of 2% or more and less than 4%
C: a nozzle non-ejection of 4% or more

### 3.3.3 Abrasion Resistance of Printed Matter

The ink jet ink composition obtained above was charged into the SC R5050, and a solid pattern (color ink adhesion amount: 12 mg/inch²) was printed on the recording medium based on the printing conditions. After being left to stand at room temperature for 30 minutes, the ink adhesion section was cut into a 25×150 mm rectangle, and the degree of peeling of the ink when rubbed 100 times with a Gakushin type rubbing resistance tester (load: 500 g) using a plain-woven cloth moistened with water was visually evaluated and determined according to the following evaluation criteria.

### Evaluation Criteria

AA: no peeling
A: peeling of less than 20% with respect to the evaluation area
B: peeling of less than 50% with respect to the evaluation area
C: peeling of 50% or more with respect to the evaluation area

### 3.4 Evaluation Results

Table 3 shows the evaluation results.

From the evaluation results shown in Table 3, it was found that a water-based ink jet ink composition, the ink jet ink composition being used for recording on a recording medium that is a low-absorbent recording medium or a non-absorbent recording medium, the ink jet ink composition containing a pigment, resin particles, a surfactant, and a poorly water-soluble low-molecular-weight organic compound that is either an alkanediol or a glycol ether and that has a solubility in water of 10 g/100 g of water or less, wherein the surfactant contains a silicone-based surfactant and an acetylene glycol-based surfactant having an HLB value of 9 to 14, and the ink jet ink composition has a pH of 8 to 10, provided excellent image quality and was also excellent in the clogging recoverability of the ink jet head.

In contrast, the ink jet ink compositions according to Comparative Examples, which did not satisfy the above configuration, were inferior in at least one of image quality or clogging recoverability.

Although not shown in the table, each evaluation was performed in the same manner as in Example 1 except that the recording medium was changed to a PET film (product name: “window-grip® ultra clear,” manufactured by Neschen Coating). The evaluation results were B in image quality, A in clogging recoverability, and A in abrasion resistance. Thus, it was found that excellent effects were also obtained in printing on the PET film. In addition, when recording was performed on plain paper as a recording medium that was neither a low-absorbent recording medium nor a non-absorbent recording medium, since the ink spread on the recording medium while being absorbed thereinto, there was no poor filling, but the recorded matter had poor abrasion resistance and water resistance.

The following are derived from the above-mentioned embodiments.

An aspect of an ink jet ink composition is a water-based ink jet ink composition. The ink jet ink composition is used for recording on a recording medium that is a low-absorbent recording medium or a non-absorbent recording medium. The ink jet ink composition contains a pigment, resin particles, a surfactant, and a poorly water-soluble low-molecular-weight organic compound that is either an alkanediol or a glycol ether and that has a solubility in water of 10 g/100 g of water or less. The surfactant contains a silicone-based surfactant and an acetylene glycol-based surfactant having an HLB value of 9 to 14. The ink jet ink composition has a pH of 8 to 10.

In the aspect of the ink jet ink composition, the ink jet ink composition may further contain an alkanediol having 4 to 6 carbon atoms as a water-soluble low-molecular-weight organic compound in an amount of 1 to 5% by mass with respect to a total amount of the ink composition.

In any aspect of the ink jet ink composition, a content of the poorly water-soluble low-molecular-weight organic compound may be 0.1 to 2% by mass with respect to a total amount of the ink composition.

In any aspect of the ink jet ink composition, the ink jet ink composition may contain the poorly water-soluble low-molecular-weight organic compound that is the alkanediol.

In any aspect of the ink jet ink composition, a total content of the acetylene glycol-based surfactant having an HLB value of 9 to 14 and the silicone-based surfactant may be 0.1 to 1% by mass with respect to a total amount of the ink composition.

In any aspect of the ink jet ink composition, the silicone-based surfactant may have a cloud point of 40° C. or higher.

In any aspect of the ink jet ink composition, the ink jet ink composition may further contain an alkanolamine having a normal boiling point of 280° C. or higher in an amount of 0.2% by mass or more with respect to a total amount of the ink composition.

In any aspect of the ink jet ink composition, the recording medium may have a printing surface formed of polyvinyl chloride.

An aspect of a recording method includes ejecting the ink jet ink composition of any of the above aspects from an ink jet head to cause the ink jet ink composition to adhere to a recording medium that is a low-absorbent recording medium or a non-absorbent recording medium.

The present disclosure is not limited to the above-mentioned embodiments, and various modifications can be made. For example, the present disclosure includes configurations that are substantially the same as the configurations described in the embodiments, for example, configurations having the same function, method, and effect, or configurations having the same object and effect. The present disclosure also includes configurations in which non-essential parts of the configuration described in the embodiments are replaced. In addition, the present disclosure includes configurations that achieve the same operational effects or configurations that can achieve the same objects as those of the configurations described in the embodiments. The present disclosure also includes configurations in which a known technology is added to the configurations described in the embodiments.

What is claimed is:

1. A water-based ink jet ink composition,
the ink jet ink composition being used for recording on a recording medium that is a low-absorbent recording medium or a non-absorbent recording medium, the ink jet ink composition comprising:
a pigment;
resin particles;
a surfactant; and
a poorly water-soluble low-molecular-weight organic compound that is either an alkanediol or a glycol ether and that has a solubility in water of 10 g/100 g of water or less, wherein
the surfactant contains a silicone-based surfactant and an acetylene glycol-based surfactant having an HLB value of 9 to 14, and
the ink jet ink composition has a pH of 8 to 10.

2. The ink jet ink composition according to claim 1, further comprising an alkanediol having 4 to 6 carbon atoms as a water-soluble low-molecular-weight organic compound in an amount of 1 to 5% by mass with respect to a total amount of the ink composition.

3. The ink jet ink composition according to claim 1, wherein a content of the poorly water-soluble low-molecular-weight organic compound is 0.1 to 2% by mass with respect to a total amount of the ink composition.

4. The ink jet ink composition according to claim 1, wherein the ink jet ink composition comprises the poorly water-soluble low-molecular-weight organic compound that is the alkanediol.

5. The ink jet ink composition according to claim 1, wherein a total content of the acetylene glycol-based surfactant having an HLB value of 9 to 14 and the silicone-based surfactant is 0.1 to 18 by mass with respect to a total amount of the ink composition.

6. The ink jet ink composition according to claim 1, wherein the silicone-based surfactant has a cloud point of 40° C. or higher.

7. The ink jet ink composition according to claim 1, further comprising an alkanolamine having a normal boiling point of 280° C. or higher in an amount of 0.2% by mass or more with respect to a total amount of the ink composition.

8. The ink jet ink composition according to claim 1, wherein the recording medium has a printing surface formed of polyvinyl chloride.

9. A recording method comprising ejecting the ink jet ink composition according to claim 1 from an ink jet head to cause the ink jet ink composition to adhere to a recording medium that is a low-absorbent recording medium or a non-absorbent recording medium.
